(19) United States
(12) Patent Application Publication
(10) Pub. No.: US 2008/0134731 A1
(43) Pub. Date: Jun. 12, 2008

(54) UMBRELLA STORAGE DEVICE AND UMBRELLA HOLDING LOCK

(75) Inventor: Koumi Manabe, Tokyo (JP)

Correspondence Address: OSHA LIANG L.L.P., 1221 MCKINNEY STREET, SUITE 2800, HOUSTON, TX, 77010, US

(73) Assignee: SUGATSUNE KOGYO CO., LTD., Tokyo (JP)

(21) Appl. No.: 11/939,446

(22) Filed: Nov. 13, 2007

Related U.S. Application Data
(62) Division of application No. 10/518,678, filed on Dec. 17, 2004.

(30) Foreign Application Priority Data
Jun. 24, 2002 (JP) 2002-183010
Apr. 17, 2003 (JP) 2003-112474
Apr. 21, 2003 (JP) 2003-115762

(51) Int. Cl. E05B 73/02

(52) U.S. Cl. 70/59

(57) ABSTRACT

A supporting column part 2 is erected from a rear end part of a water receiving part 3. A basal end part of a supporting member 4 is rotatably disposed at an upper end part of the supporting column part 2. The supporting member 4 is, when in use of an umbrella storage apparatus A, rotated such that the supporting member 4 becomes horizontal in posture and positionally fixed. A plurality of umbrella retaining locks 5, 5′ are disposed, side by side in the longitudinal direction of the supporting member 4, at left and right side parts of the supporting member 4. The water-drops dropping from the umbrellas retained by the umbrella retaining locks 5, 5′ are received in the water receiving part 3.

### CROSS REFERENCE TO RELATED APPLICATIONS

This is a divisional of U.S. patent application Ser. No. 10/518,678 filed on Dec. 17, 2004, which is a national phase application of PCT/JP03/07913 filed on Jun. 23, 2003, which claims priority of JP 2002-183010 filed on Jun. 24, 2002, JP 2003-122474 filed on Apr. 17, 2003, and JP 2003-115762 filed on Apr. 21, 2003.

### TECHNICAL FIELD

This invention relates to an umbrella storage apparatus and an umbrella retaining lock suited to be used for the umbrella storage apparatus.

### BACKGROUND ART

In general, an umbrella storage apparatus includes an apparatus main body, a plurality of supporting members arranged in mutually parallel relation at upper end part of the apparatus main body, and a plurality of umbrella retaining locks arranged, side by side, at least at one side part of each supporting member in the longitudinal direction of the supporting members. The umbrella retaining locks retain the grip parts (parts-to-be-retained) of the umbrellas to be stored in their locked states (see Official Gazette of Japanese Patent Application Laid-Open No. H08-308711).

In the above-mentioned conventional umbrella storage apparatus, gaps between one end parts and between the other end parts in the longitudinal direction of the mutually adjacent supporting members are closed, respectively. Therefore, in case an umbrella is inserted between the supporting members so that the umbrella is retained by the umbrella retaining lock, the entire umbrella must be once lifted up to a level above the supporting members and then inserted between the supporting members. However, there is such a problem that when the umbrella is lifted up to the level above the supporting members, the grips, etc. of umbrellas which are already stored in the umbrella storage apparatus will get wet by waterdrops dropping from the ferrule of the umbrella. Moreover, it is difficult for children who are not yet high enough to lift up the umbrellas to the level above the supporting members and so, they cannot utilize the umbrella storage apparatus.

### DISCLOSURE OF THE INVENTION

In order to solve the above problem, the first embodiment of the present invention is characterized by comprising an apparatus main body, a supporting member arranged with a longitudinal direction thereof directing in a direction intersecting with an up and down direction and with a basal part thereof supported on the apparatus main body, and a plurality of umbrella retaining locks disposed, side by side, on at least one side part of the supporting member along the longitudinal direction of the supporting member and adapted to retain a part-to-be-retained of the umbrella.

In this case, it is preferred that the apparatus main body is provided at least at one side part thereof with a reference plane directing in an arrangement direction orthogonal to an up and down direction and a longitudinal direction of the supporting member, and the reference plane is arranged to be separated by a predetermined distance or more in the arrangement direction from the umbrella retaining lock.

It is preferred that the basal end part of the supporting member is rotatably supported on the apparatus main body about a horizontal axis between a use position where the longitudinal direction of the supporting member is directed in a direction intersecting with the up and down direction and a receipt position where the distal end part is located generally downward of the basal end part and the entire supporting member is disposed generally along the apparatus main body, the apparatus main body is rotatably provided with a cosmetic cover, the cosmetic cover can rotate between an open position and a closed position, the cosmetic cover, when located in the open position, allows the supporting member to rotate between the use position and the receipt position and when located in the closed position, covers the supporting member located in the receiving position and the umbrella retaining lock in co-action with the apparatus main body.

In order to solve the above problem, the second embodiment of the present invention is characterized by comprising an apparatus main body, a plurality of supporting members arranged with a longitudinal direction thereof directing in a direction intersecting with an up and down direction and with basal parts thereof supported on the apparatus main body, a plurality of umbrella retaining locks disposed, side by side, on at least one side parts of the supporting members along the longitudinal direction of the supporting member and each adapted to retain a part-to-be-retained of the umbrella, the supporting members are mutually spacedly arranged in the horizontal direction, and a gap between the mutually adjacent two supporting members and an extension part of the gap downward by a predetermined distance are open forward in the longitudinal direction of the supporting members.

In this case, it is preferred that the plurality of supporting members are arranged in mutually parallel relation.

It is preferred that the apparatus main body is provided at least at one side part thereof in the separation direction of the plurality of supporting members with a reference plane directing toward the outside in the separation direction, the reference plane is arranged to be separated outward by a predetermined distance or more from the umbrella retaining lock adjacent the inner side in the separation direction with respect to the reference plane.

It is preferred that the apparatus main body includes a plurality of supporting column parts mutually spacedly arranged on a horizontal straight line and vertically erected, and a plurality of second supporting column parts arranged in opposing relation on a straight line parallel to the straight line on which the plurality of supporting column parts are arranged and vertically erected, and the basal end parts and the distal end parts of the supporting members are supported on the mutually opposing supporting column parts and the second supporting column parts, respectively. In that case, it is preferred that at least an upper part of a gap between the mutually adjacent second supporting column parts is open forward in the longitudinal direction of the supporting member.

It is preferred that a reference plane directing toward the outside in the separation direction is disposed at least at one side part of the apparatus main body in the separation direction of the supporting member, and the reference plane is arranged to be separated outward by a predetermined distance or more from the umbrella retaining lock adjacent to the inside in the separation direction with respect to the reference plane.

It is preferred that the apparatus main body includes two supporting column parts arranged to be separated from each other in the horizontal direction and with their longitudinal direction directing in the up and down direction and a retaining member whose opposite end parts in the longitudinal direction are supported by the two supporting column parts, respectively, the plurality of supporting members are arranged to be separated from each other in the longitudinal direction of the retaining member, and the basal end parts of the supporting members are retained by the retaining member. In this case, it is preferred that a reference plane directing toward the outside in the separation direction is disposed at least at one side part of the apparatus main body in the separation direction of the two supporting column parts, and the reference plane is arranged to be separated outward by a predetermined distance or more from the umbrella retaining lock adjacent to the inside in the separation direction with respect to the reference plane.

It is preferred that the umbrella retaining lock includes a lock main body attached to a side part of the supporting member and formed in a front surface part thereof facing sideward of the supporting member with a receiving recess extending upward and downward and open sideward of the supporting member, and a lock member disposed at the lock main body such that the lock member is displaceable between a releasing position and a locking position, the lock member, when located in the releasing position, allowing a part-to-be-retained of an umbrella to be brought in and out of the receiving recess through the opening part, and when located in the locking position, prohibiting the part-to-be-retained of the umbrella from escaping from the receiving recess through the opening part, and a deepest part of the receiving recess is offset toward the longitudinal direction of the supporting member with respect to a central part of the opening part of the receiving recess.

It is preferred that the umbrella retaining lock includes a lock main body attached to a side part of the supporting member and formed in a front surface part thereof facing sideward of the supporting member with a receiving recess extending upward and downward and open sideward of the supporting member, and a lock member disposed at the lock main body such that the lock member is displaceable between a releasing position and a locking position, the lock member, when located in the releasing position, allowing a part-to-be-retained of an umbrella to be brought in and out of the receiving recess through the opening part, and when located in the locking position, prohibiting the part-to-be-retained of the umbrella from escaping from the receiving recess through the opening part, and a depth direction of the receiving recess is inclined with respect to the longitudinal direction of the supporting member so that the depth of the receiving recess becomes deeper from on the longitudinal direction of the supporting member toward the other end.

The first embodiment of an umbrella retaining lock according to the present invention is characterized by including a lock main body formed in a front surface thereof with a receiving recess extending in the up and downward direction and open forward, and a lock member disposed at the lock main body such that the lock member is displaceable between a releasing position and a locking position, the lock member, when located in the releasing position, allowing a part-to-be-retained of an umbrella to be brought in and out of the receiving recess through the opening part, and when located in the locking position, prohibiting the part-to-be-retained of the umbrella from escaping from the receiving recess through the opening part, wherein a deepest part of the receiving recess is offset in the horizontal direction along the front surface of the lock main body with respect to a central part in the horizontal direction of the opening part of the receiving recess.

The second embodiment of an umbrella retaining lock according to the present invention is characterized by including a lock main body formed in a front surface thereof with a receiving recess extending in the up and downward direction and open forward, and a lock member disposed at the lock main body such that the lock member is displaceable between a releasing position and a locking position, the lock member, when located in the releasing position, allowing a part-to-be-retained of an umbrella to be brought in and out of the receiving recess through the opening part, and when located in the locking position, prohibiting the part-to-be-retained of the umbrella from escaping from the receiving recess through the opening part, wherein a depth direction of the receiving recess is inclined with respect to the front surface of said lock main body so that the depth of the receiving recess becomes deeper toward the horizontal direction along the front surface of the lock main body.

In the above-mentioned umbrella retaining lock, it is preferred that a movable member with a part thereof projecting from a bottom surface of the receiving recess is disposed at the apparatus main body such that the movable member is displaceable in the depth direction of the receiving recess, and the movable member is connected to the lock member so that when the movable member is abutted with the part-to-be-retained of the umbrella inserted in the receiving recess and then displaced toward the deep side of the receiving recess together with the part-to-be-retained, the lock member is displaced toward the locking position side from the releasing position interlocking with the displacement of the movable member.

It is preferred that an intermediate part located within the apparatus main body of the lock member is rotatably disposed at the apparatus main body for rotation about an axis extending in the up and down direction, the lock member is provided at one end part thereof projecting toward the outside from the apparatus main body with an engagement part for prohibiting the part-to-be-retained of the umbrella from escaping from the opening part of the receiving recess when the lock member is located in the locking position, and the movable member is integrally disposed at the other end part projecting from a bottom surface within the receiving recess of the lock member.

It is preferred that the bottom surface of the receiving recess includes a pair of side surfaces extending in parallel relation to each other toward the deep side of the receiving recess from an opening part thereof, and a deep surface disposed between end parts on the deep side of the pair of side surfaces, a recess is formed in an area in the vicinity of an opening part of a side surface opposing the opening part of the receiving recess of the pair of side surfaces, and a part of the engagement part is received in the recess so that when the lock member is located in the releasing position, the engagement part is not projected toward the outside from the opening part of the receiving recess and a part-to-be-retained of an umbrella inserted in the receiving recess through the opening part thereof is not abutted with the engagement part.

### BRIEF DESCRIPTION OF DRAWINGS

FIG. 1 is a side view showing the first embodiment of an umbrella storage apparatus according to the present invention.

FIG. 2 is a plan view of the above embodiment.

FIG. 3 is a front view of the above embodiment.

FIG. 4 is a plan view showing the above embodiment with a supporting member and a water retainer received in a supporting column part.

FIG. 5 is a plan view showing a pair of umbrella retaining locks attached to opposite side parts of the supporting member in the above embodiment.

FIG. 6 is a view when viewed in a direction as indicated by an arrow X of FIG. 5.

FIG. 7 is a view when viewed in a direction as indicated by an arrow Y of FIG. 5.

FIG. 8 is a plan view showing one of the pair of umbrella retaining locks of FIG. 5.

FIG. 9 is a lower surface view in which a lower half part of the umbrellas retaining lock of FIG. 8 is removed and the lock member is located in a releasing position.

FIG. 10 is a view, like FIG. 9, in which the lock member of the above umbrella retaining lock is located in a lock start position.

FIG. 11 is view, like FIG. 9, in which the lock member of the above umbrella retaining lock is located in a locking position.

FIG. 12 is a view showing the lock member used in the above umbrella retaining lock, FIG. 12(A) is a view when viewed in a direction as indicated by an arrow A of FIG. 12(B), FIG. 12(B) is a plan view, and FIG. 12(C) is a view when viewed in a direction as indicated by an arrow C of FIG. 12(B).

FIG. 13 is a view showing a key shaft used in the above umbrella retaining lock, FIG. 13(A) is a front view, FIG. 13(B) is a sectional view taken on line B-B of FIG. 13(C), FIG. 13(C) is a plan view, and FIG. 13(D) is a sectional view taken on line D-D of FIG. 13(A).

FIG. 14 is a front view showing the second embodiment of an umbrella storage apparatus according to the present invention.

FIG. 15 is a plan view of the above embodiment.

FIG. 16 is a side view of the above embodiment.

FIG. 17 is a side view showing the above embodiment, in which a supporting member is rotated in a receiving position and a water receiving part is rotated in a folding position.

FIG. 18 is a front view showing the third embodiment of an umbrella storage apparatus according to the present invention.

FIG. 19 is a plan view of the above embodiment.

FIG. 20 is a side view of the above embodiment.

FIG. 21 is a sectional view taken on line X-X of FIG. 19.

FIG. 22 is a perspective view showing the fourth embodiment of an umbrella storage apparatus according to the present invention.

FIG. 23 is a front view of the above embodiment.

FIG. 24 is a plan view of the above embodiment.

FIG. 25 is a side view of the above embodiment.

FIG. 26 is a perspective view showing an umbrella retaining lock used in the above embodiment.

FIG. 27 is a perspective view showing the fifth embodiment of an umbrella storage apparatus according to the present invention.

FIG. 28 is a front view of the above embodiment.

FIG. 29 is a plan view of the above embodiment.

FIG. 30 is a side view of the above embodiment

FIG. 31 is a perspective view showing the sixth embodiment of an umbrellas storage apparatus according to the present invention.

FIG. 32 is a front view of the above embodiment.

FIG. 33 is a plan view of the above embodiment.

FIG. 34 is a side view of the above embodiment.

FIG. 35 is a perspective view showing another example of an umbrella retaining lock suitably used in an umbrella storage apparatus according to the present invention.

FIG. 36 is a plan view showing an essential part of the seventh embodiment of an umbrella storage apparatus according to the present invention.

FIG. 37 is a plan view showing an essential part of the eighth embodiment of an umbrella storage apparatus according to the present invention.

FIG. 38 is a perspective view showing the ninth embodiment of an umbrella storage apparatus according to the present invention.

### BEST MODE FOR CARRYING OUT THE INVENTION

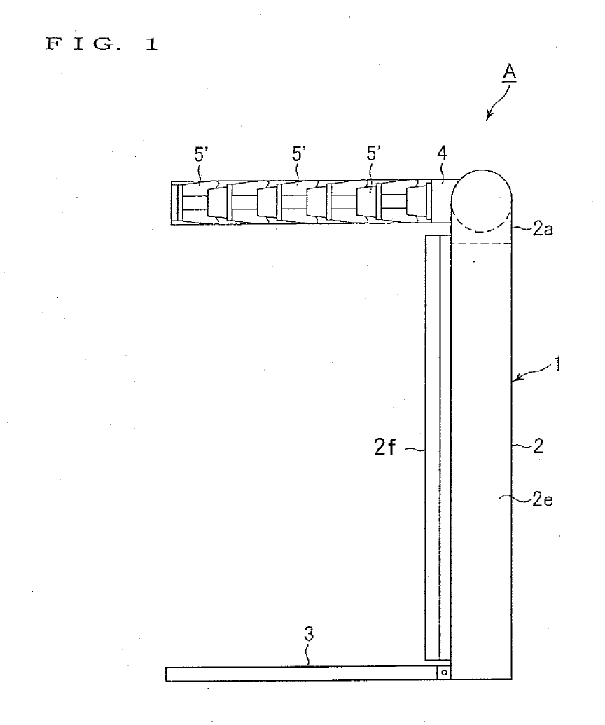

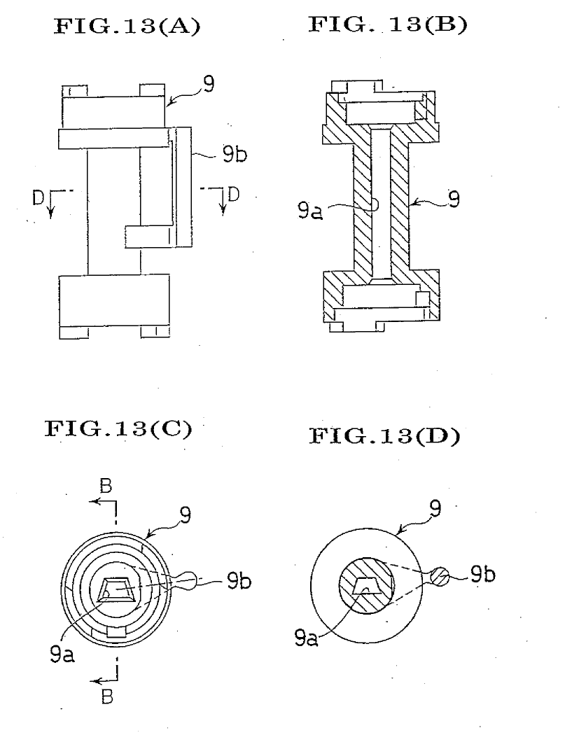

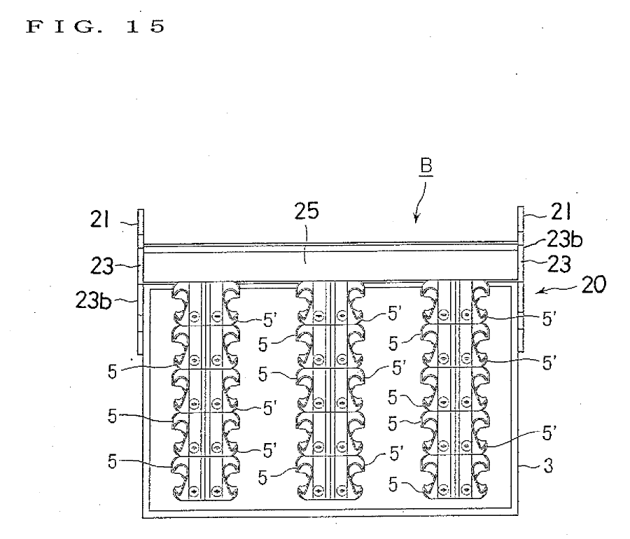

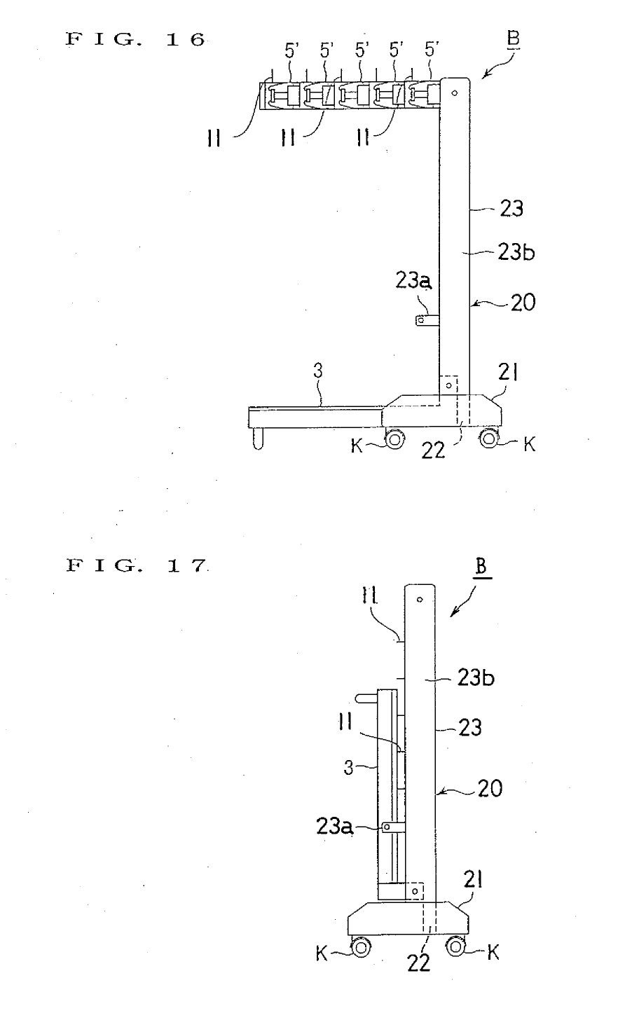

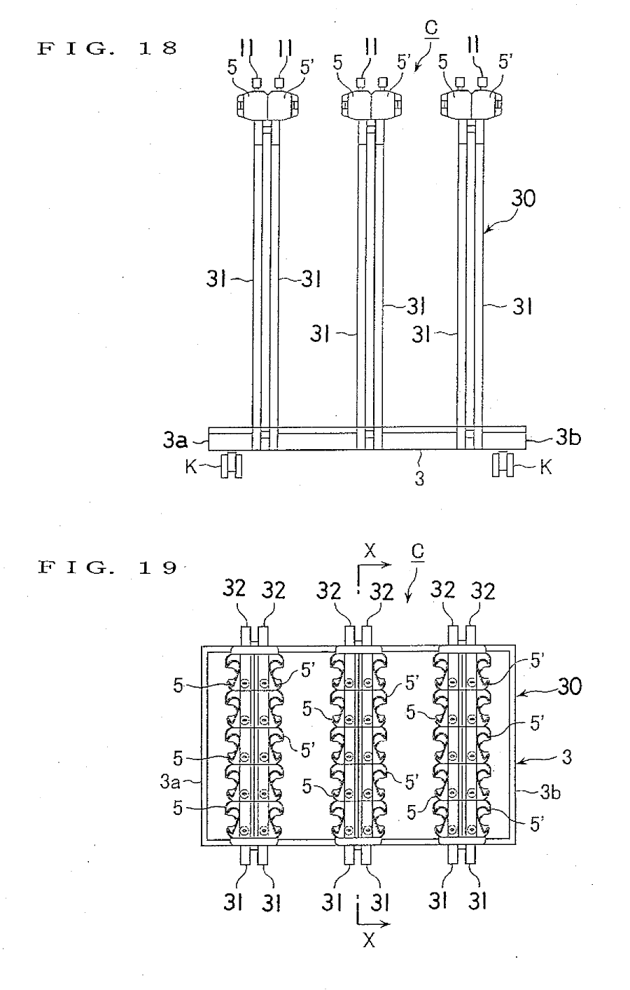

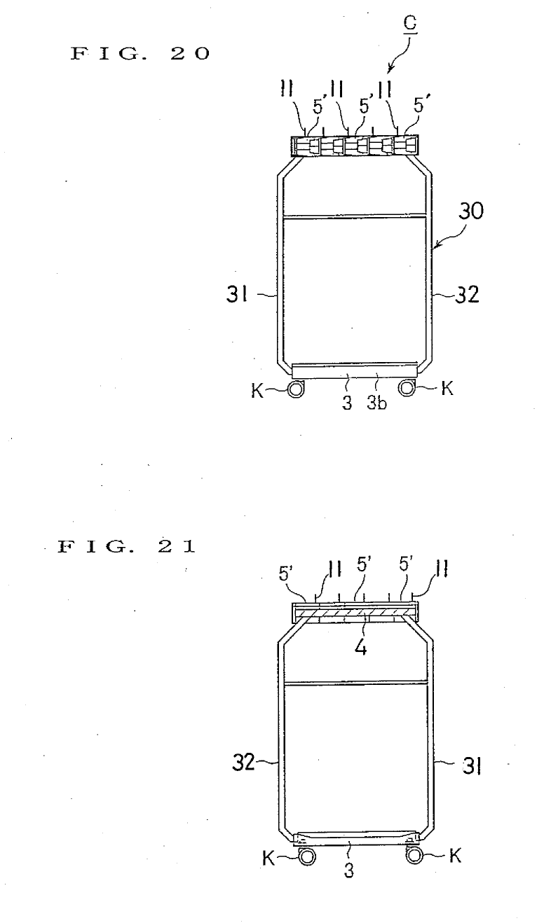

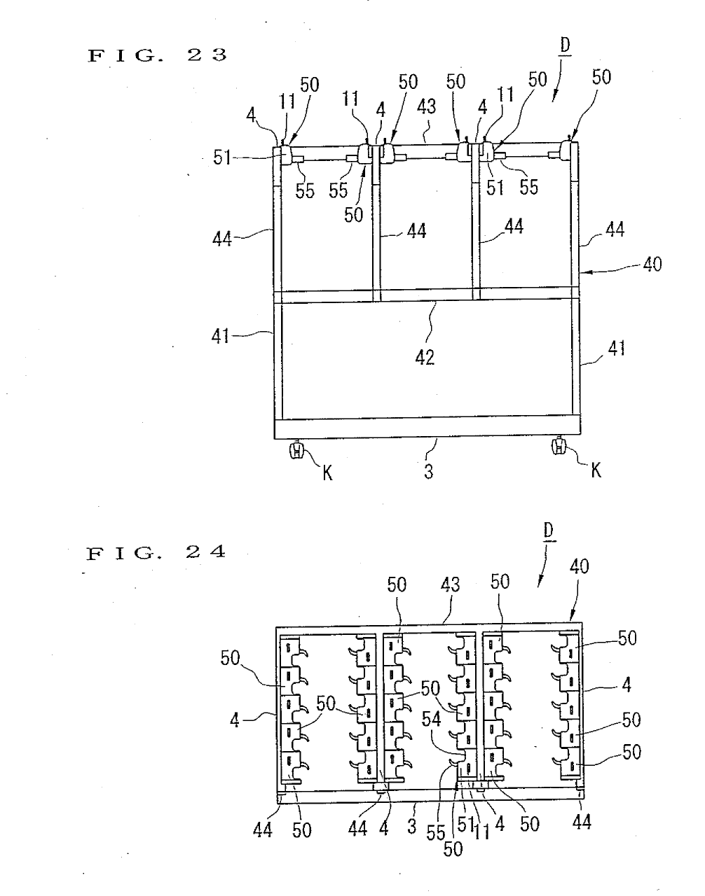

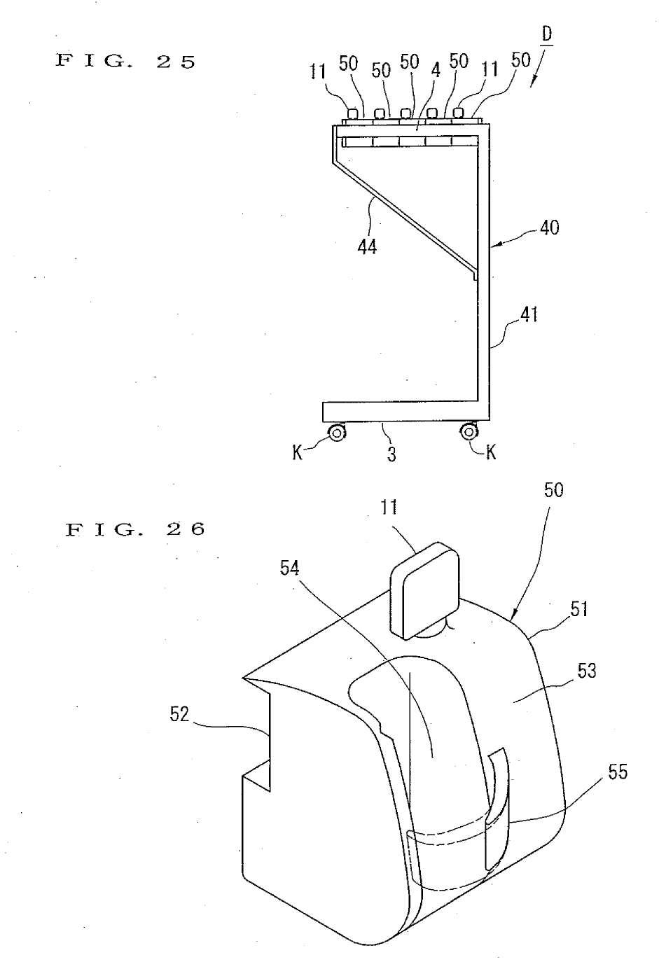

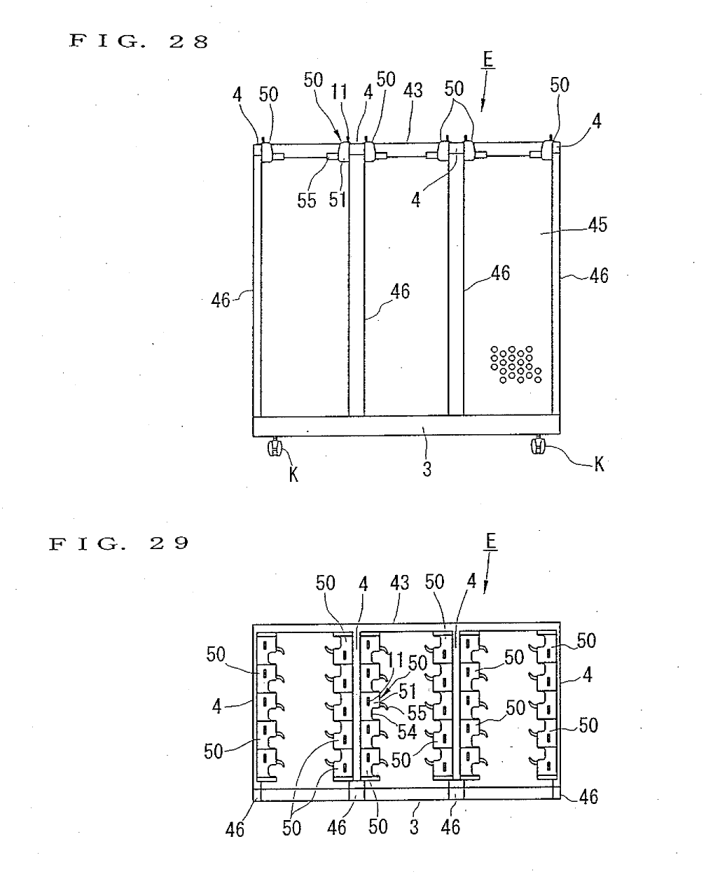

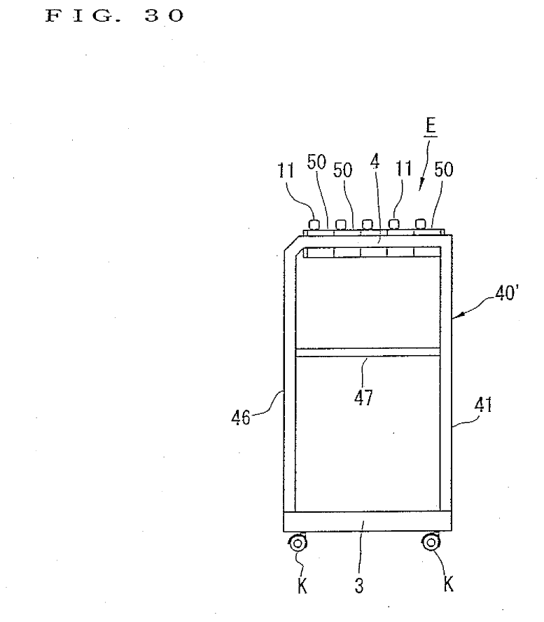

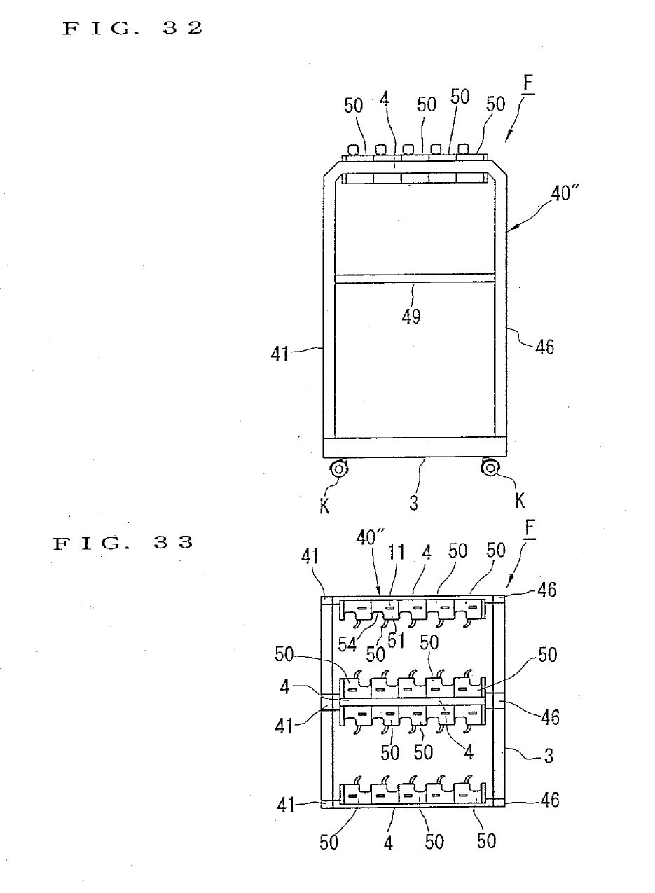

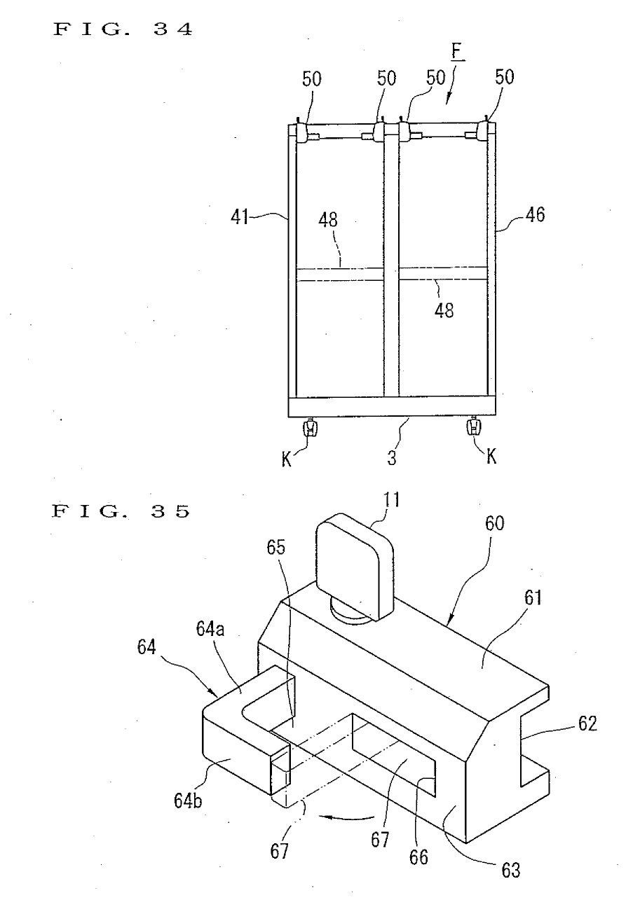

Some embodiments of the present invention will be described hereinafter with reference to FIGS. 1 through 38.

FIGS. 1 through 13 shows the first embodiment of an umbrella storage apparatus according to the present invention. An umbrella storage apparatus A of this embodiment, as shown in FIGS. 1 through 3, includes an apparatus main body 1. The apparatus main body 1 includes a supporting column part 2 erected with its longitudinal direction directing upward and downward, and a water receiving part 3 disposed at a lower end part of this supporting column part 2.

The supporting column part 2 is formed in a box-like configuration which is open at its front surface. A pair of mutually opposing bearing parts 2a, 2a are disposed at opposing side parts in the left and right direction of an upper end face of the supporting column part 2. The bearing parts 2a, 2a are integrally formed with the supporting column part 2. The pair of bearing parts 2a, 2a are arranged with their axes directing in the left and right direction and aligned with each other. A notch part 2b is formed at an upper end part of the front surface of the supporting column part 2. This notch part 2b is arranged in such a manner as to be located between the pair of bearing parts 2a, 2a in the left and right direction. A notch part 2c is formed at a lower end part of the front surface of the supporting column part 2. This notch part 2c is arranged at a generally same position as the notch part 2b in the left and right direction. The notch part 2c has an approximately same width (width in the left and right direction) as the notch part 2b.

A basal end part of the supporting member 4 is inserted between the pair of bearing parts 2a, 2a. The basal end part of the supporting member 4 is rotatably supported by the bearing parts 2a, 2a about a horizontal axis extending in the left and right direction. The rotating range of the supporting member 4 is restricted to between a use position where a distal end part of the supporting member 4 becomes approximately same in height as the basal part and as a result, the entire supporting member 4 becomes generally horizontal in posture and a receipt position where the distal end part of the supporting member 4 is located normal and downward to the basal end part. A lock mechanism (not shown) is disposed between the supporting member 4 and the supporting column part 2. When the supporting member 4 is held in the use position and the lock mechanism is held in the locked state, the supporting member 4 is maintained in the use position. When the locked state caused by the locking mechanism is released, the supporting member 4 becomes able to rotate from the use position to the receipt position. When the supporting member 4 is rotated into the receipt position, its part adjacent to the bearing parts 2a, 2a on the lower side is brought into the notch part 2b and its part located on the lower side of the notch part 2b is almost entirely received in the supporting column part 2.

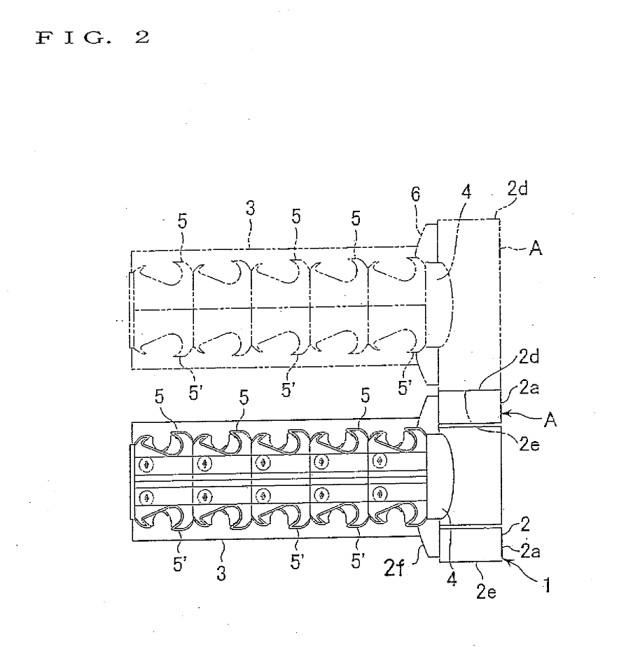

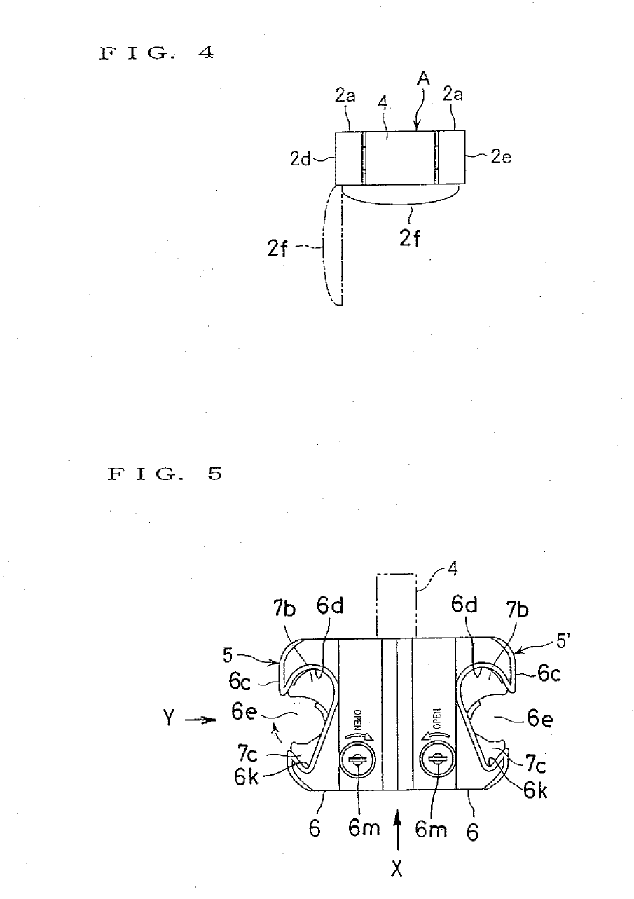

As shown in FIGS. 2, 5 and 6, a plurality of umbrella retaining locks 5 are arranged at one side part (left side part in FIG. 5) in the left and right direction of the supporting member 4 along the longitudinal direction of the supporting member 4, and a plurality of umbrella retaining locks 5′ are arranged at the other side part along the longitudinal direction of the supporting member 4. The umbrella retaining locks 5, 5′, which are adjacent in the direction orthogonal to the longitudinal direction of the supporting member 4, are arranged at the same position in the longitudinal direction of the supporting member 4. Since the umbrella retaining locks 5, 5′ are fixed to the supporting member 4, when the supporting member 4 is rotated between the use position and the receipt position, the locks 5, 5′ are also rotated integrally with the supporting member 4. Moreover, the umbrella retaining locks 5, 5′ are almost entirely received in the supporting column part 2 when the supporting member 4 is rotated into the receipt position. The construction of the umbrella retaining locks 5, 5′ will be described later.

The left side surface 2d and the right side surface 2e of the supporting column part 2 are each comprised of a normal plane orthogonal to the axis of the bearing part 2a. The left side surface 2d is located at the leftmost side in the entire umbrella storage apparatus A, and the right side surface 2e is located at the rightmost side in the entire umbrella storage apparatus A. The left side surface 2d and the right side surface 2e each serves as a reference plane (hereinafter, the left side surface 2d is referred to as the “left reference plane” and the right side surface 2e is referred to as the “right reference plane”). Instead of serving the entire left and right side surfaces 2d, 2e each as a reference plane, it is accepted that a projection part projecting in the left side direction is formed on a part of the side surface 2d and a projection part projecting in the right side direction is formed on a part of the side surface 2e, so that only distal end faces of the projection parts may serve as a reference plane. The same is true for each of the embodiments to be described hereinafter. A front surface 6c facing leftward of the umbrella retaining lock 5 is arranged to be separated inward by a predetermined distance with respect to the left reference plane 2d. A front face 6c facing rightward of the umbrella retaining lock 5′ is arranged to be separated inward by the same distance between the front surface 6c of the umbrella retaining lock 5 and the left reference plane 2d with respect to the right reference plane 2e. The distance between the left reference plane 2d and the front surface 6c of the umbrella retaining lock 5, and the distance between the right reference plane 2e and the front surface 6c of the umbrella retaining lock 5′ are same. The distances are set to any one of the following dimensions, for example.

Presume here that the left reference plane 2d is face-contacted with a normal wall surface so that the supporting member 4 becomes parallel to the normal wall surface. Then, a gap having the same dimension as the distance between the left reference plane 2d and the front surface 6c is formed between the normal wall surface and the front surface 6c of the umbrella retaining lock 5. The distance between the left reference plane 2d and the front surface 6c is established such that an umbrella can be inserted between the normal wall surface and the front surface 6c of the umbrella retaining lock 5 through this gap. In the like manner, the distance between the right reference plane 2e and the front surface 6c of the umbrella retaining lock 5′ is established.

Otherwise, as shown in FIG. 2 or 3, presume that a plurality of umbrella storage apparatuses A are, side by side, arranged in the left and right direction such that the left reference plane 2d of one umbrella storage apparatus A and the right reference plane 2e of the other umbrella storage apparatus A are face-contacted with each other. By arranging so, a gap having a dimension twice as large as the distance between the left reference plane 2e and the front surface 6c of the umbrella retaining lock 5 (this distance is equal to the distance between the right reference plane 2e and the front surface 6c of the umbrella retaining lock 5′) is formed between the front surface 6c of the umbrella retaining lock 5 of the one umbrella storage apparatus A and the front surface 6c of the umbrella retaining lock 5′ of the other umbrella storage apparatus A which is adjacent to the one umbrella storage apparatus A. The distance between the left reference plane 2d and the front surface 6c and the distance between the right reference plane 2e and the front surface 6c are established such that the umbrella can be inserted between the front surfaces 6c, 6c of the umbrella retaining locks 5, 5′ of the adjacent two umbrella storage apparatuses A, A through this gap.

A basal end part of the water receiving part 3 is rotatably supported on a lower end part of the front surface of the supporting column part 2 about the horizontal axis. The water receiving part 3 is formed in a rectangular container, in a plan view, having an open top and a small depth. The water receiving part 3 is determined in its length in the back and forth direction and its width in the left and right direction such that any waterdrop dropping from any umbrella retained by any umbrella retaining lock 5, 5′ can be received in the receiving part 3. Moreover, the width of the water receiving part 3 is established to be narrower than the width in the left and right direction of the supporting column part 2, i.e., the distance between the left and right reference places 2d, 2e within a range capable of satisfying such conditions. Accordingly, the opposite side surfaces of the water receiving part 3 is located on the inner side in the left and right direction of the reference planes 2d, 2e of the supporting column part 2.

The rotating range of the water receiving part 3 is restricted to between a water receiving position shown in FIG. 1 where the distal end part of the water receiving part 3 extends generally horizontally forward from the supporting column part 2 and a folding position where the distal end part extends generally normally upward from the basal end part. The water receiving part 3 is rotated into the use position when the umbrella storage apparatus A is normally in use. The water receiving part 3 rotated into the use position receives waterdrops dropping from the umbrellas retained by the umbrella retaining locks 5, 5′. On the other hand, the water receiving part 3 is rotated into the folding position when the umbrella storage apparatus A is not in use. The water receiving part 3 rotated into the folding position is mostly received in the supporting column part 2. At that time, the water receiving part 3 is generally in contact with the upper surfaces of keys 11, 11 of the umbrella retaining locks 5, 5′ which are located in the receipt position.

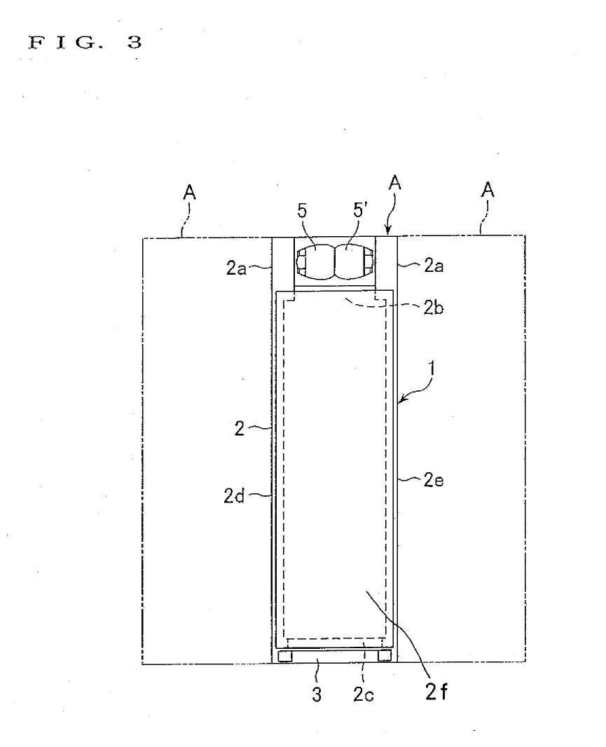

One side part of a cosmetic cover 2f is disposed at one side part in the left and right direction of the front surface of the supporting column part 2 such that the cosmetic cover 2f can rotate between a closed position indicated by a solid line and an open position as indicated by an imaginary line in FIG. 4 about an axis directing in the up and down direction. When the cosmetic cover 2f is located in the open position, the supporting member 4 and the umbrella retaining locks 5, 5′ are allowed to rotate between the use position and the receiving position and the water receiving part 3 is allowed to rotate between a water receiving position and a folding position. When the cosmetic cover 2f is located in the closed position, it covers fully the entire supporting member 4 which is rotated into the receiving position only excluding the upper end part, the entire umbrella retaining locks 5, 5′ disposed at the supporting member 4, and the water receiving part 3 which is rotated in the folding position. Even when the umbrella storage apparatus A is in use wherein the supporting member 4 is in the use position and the water receiving part 3 is in the water receiving position, the cosmetic cover 2f is rotated to the closed position to cover the inside of the supporting column part 2. The width in the left and right direction of the cosmetic cover 2f is narrower than the width in the left and right direction of the supporting column part 2. When the cosmetic cover 2f is located in the closed position, the opposite side surfaces in the left and right direction of the cover 2f are located on the inner side in the left and right direction of the left and right reference planes 2d, 2e of the supporting column part 2.

Next, the construction of the umbrella retaining locks 5, 5′ will be described. As apparent from FIGS. 2 and 5, since the umbrella retaining locks 5, 5′ are symmetrically constructed with respect to a line passing through the center of the supporting member 4, only one umbrella retaining lock 5 will be described. With respect to the other umbrella retaining lock 5′, identical component parts to those of the umbrella retaining lock 5 are denoted by identical reference numeral and description thereof is omitted.

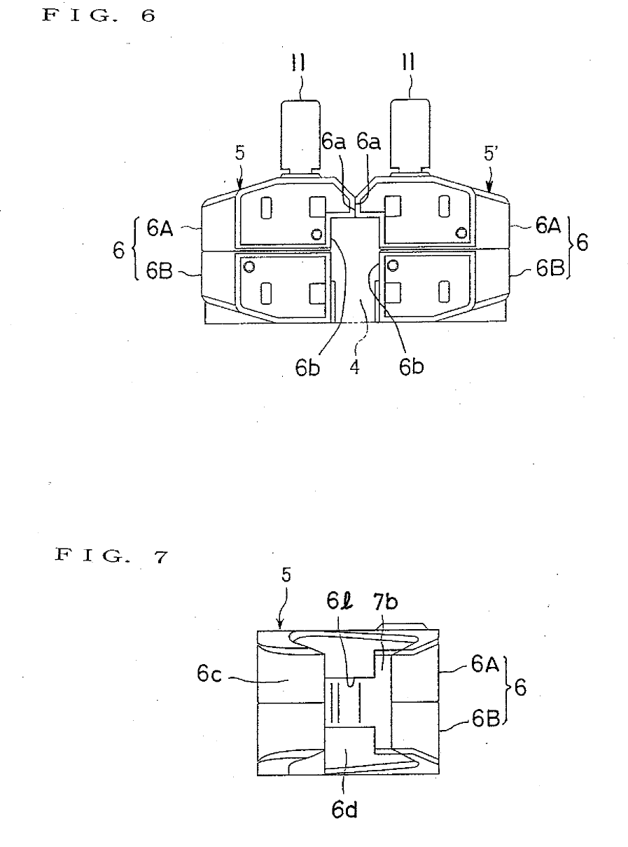

As shown in FIGS. 6 and 7, the umbrella retaining lock 5 includes a main body part 6. The main body part 6 consists of an upper half member GA and a lower half member 6B. Both the upper and lower half members 6A, 6B are obtained by molding from hard resin. The upper half members 6A and the lower half member 6B are fixed with each other in their vertically opposing postures. By this, the main body part 6 having a hollow rectangular parallelepiped configuration is constructed. An attachment recess 6b is formed in a rear surface 6a of the main body part 6 in such a manner as to transverse the rear surface 6a in the longitudinal direction of the supporting member 4. By fixedly inserting one side part of the supporting member 4 in this attachment recess 6b, the main body part 6 is attached to the supporting member 4 with its front surface 6c directing in the horizontal direction which is orthogonal to the longitudinal direction of the supporting member 4.

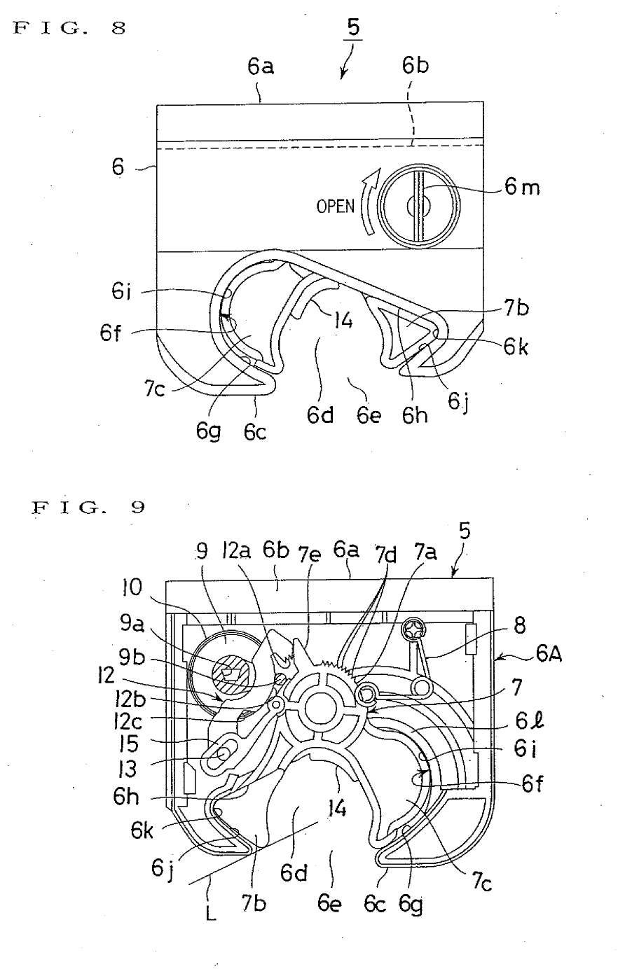

A receiving recess 6d is formed in the front surface 6c of the main body part 6. As shown in FIGS. 8 through 11, the receiving recess 6d allows a grip part (part-to-be-retained) of the umbrella retained by the umbrella retaining lock 5 to insert therein, and transverses the front surface 6c in the up and down direction. The deepest part of the receiving recess 6d is offset to the basal end side of the supporting member 4 with respect to the central part of an opening part 6e of the receiving recess 6d in the horizontal direction (left and right direction in FIG. 8) along the front surface 6c. That is, the depth of the receiving recess 6d becomes gradually larger toward the basal end side from the distal end side of the supporting member 4. The depth direction of the receiving recess 6d is inclined with respect to the longitudinal direction (left and right direction in FIG. 8) of the supporting member 4. This inclination angle is preferably set to about 30 degrees to 45 degrees. In correspondence to inclination of the depth direction of the receiving recess 6d, the opposite side surfaces 6g, 6h, which constitute a part of the bottom surface 6f of the receiving recess 6d, is likewise inclined. By inclining the depth direction of the receiving recess 6d with respect to the front surface 6c, the location of the deepest part of the receiving recess 6d is offset to the basal end side of the supporting member 4 from the central part of the opening part 6e of the receiving recess 6d in the horizontal direction along the front surface 6c. A semi-circular arcuate surface (inner surface) 6i whose opposite end parts are in contact with the side surfaces 6g, 6h, is formed between the end parts on the inner side of the opposite side surfaces 6g, 6h. Of course, this arcuate surface 6i also constitutes a part of the bottom surface 6f.

It should be noted here that the expression “central part” of the opening part 6e refers to a place which is located at a distance D/2 from the opposite end edges, wherein D is a distance between the opposite end edges in the left and right direction in FIG. 8 of the opening part 6e. In this case, the opposite end edges of the opening part 6e are bent instead of extending straight in the up and down direction, so that the distances between the opposite end edges are different at various parts in the up and down direction, the above-mentioned “central part” refers to a central part at a place where the distance between the opposite end edges is narrowest, or it refers to a central part between a place located on the most basal end side of the supporting member 4 in the end edge (right-side end edge in FIG. 8) located on the distal end side of the supporting member 4 and a place located at the same position in the up and down direction as the first-mentioned end edge, in the end edge located on the basal end side of the supporting member 4.

A relief surface 6j is formed between the end edge located on the distal end side of the supporting member 4 in the opposite end edges which define the opening part 6e of the receiving recess 6d and the side surface 6h (side surface 6h opposing the opening part 6e) adjacent to the first-mentioned end edge. This relief surface 6j is inclined in the opposite direction to the side surface 6h. In other words, the surface 6j is inclined such that the relief surface 6j is separated from the front surface 6c toward the distal end side from the basal end side of the supporting member 4. A recess 6k is defined by the relief surface 6j and the end part on the opening part 6e side of the side surface 6h. As shown in FIGS. 7, and 9 through 11, a communication hole 61 for intercommunicating the inside of the main body part 6 and the inside of the receiving part 6d is formed the area range from the end part on the relief surface 6j side of the side surface 6h to the end part on the side surface 6g side of the arcuate surface 6i.

As shown in FIGS. 9 through 11, a lock member 7 is disposed at a generally central part of the inside of the main body part 6. The lock member 7 includes a core part (intermediate part) 7a having a generally circular configuration in section and with its axis directing in the up and down direction, an engagement part 7b integral with the core part 7a and extending outward from the outer peripheral surface of the core part 7a along its radial direction, and an abutment part (movable member) 7c integral with the core part 7a and extending outward along the radial direction of the core part 7a from a place about 90 degrees separated in the peripheral direction with respect to the engagement part 7b of the outer peripheral surface of the core part 7a.

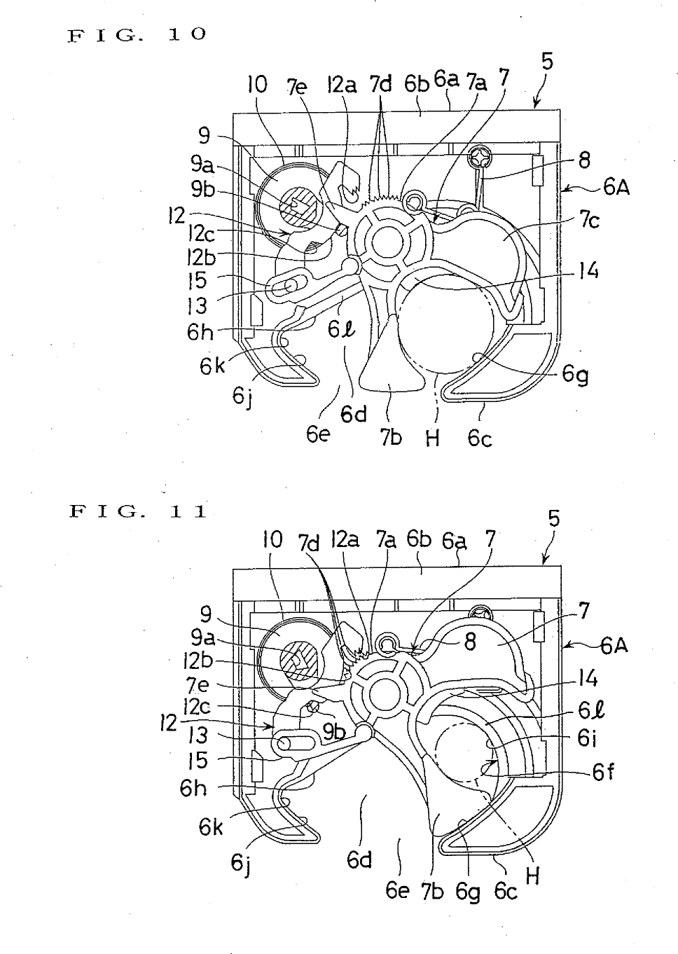

The core part 7a is disposed at the inside of the main body part 6 and positionally fixed to the main body part 6 such that the core part 7a can rotate about its own axis. The rotating range of the core part 7a, i.e., the rotating range of the lock member 7 is restricted to between a releasing position shown in FIG. 9 and a locking position shown in FIG. 11. When the lock member 7 is located between the releasing position and an intermediate position which is offset by a predetermined angle toward the releasing position side from the lock start position shown in FIG. 10, the lock member 7 is rotationally biased toward the releasing position from the locking position by a spring (rotation biasing means) disposed between the lock member 7 and the main body part 6. When the lock member 7 is located between the intermediate position and the locking position, the lock member 7 is rotationally biased toward the locking position side from the releasing position side by the afore-mentioned spring. When in the releasing position, the lock member 7 is maintained in the releasing position by the biasing force of the spring 8 and when in the locking position, the lock member 7 is maintained in the locking position by the biasing force of the spring 8.

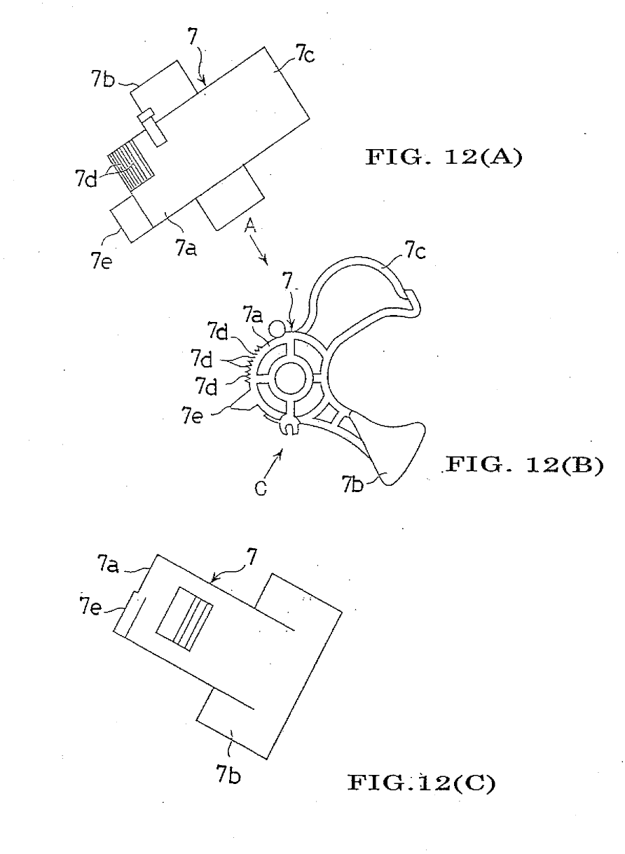

As shown in FIG. 12, a plurality of ratchet teeth 7d and a projection 7e are formed on the outer peripheral surface of the core part 7a. The ratchet teeth 7d and the projection 7e are arranged at a generally central part of one of two parts, this one being longer in peripheral direction, which are defined by the engagement part 7b and the abutment part 7c on the outer peripheral surface of the core part 7a. Moreover, the ratchet teeth 7d are arranged nearer to the abutment part 7c and the projection 7e is arranged nearer to the engagement part 7b. The ratchet teeth 7d and the projection 7e are slightly spacedly arranged in the axial direction (up and down direction) of the core part 7a.

The forward part of the engagement part 7b is projected into the receiving recess 6d through the communication hole 61 irrespective of the rotational position of the lock member 7. Especially, when the lock member 7 is located in the releasing position, the forward part (a part) of the engagement part 7b is received in the recess 6k and abutted against the side surface 6h, which defines the recess 6k, by the rotational biasing force of the spring 8. In other words, abutment of the engagement part 7b against the side surface 6h, which defines the recess 6k, restricts the releasing position of the lock member 7. When the lock member 7 is located in the releasing position, insertion of the forward part of the engagement part 7b into the recess 6k, prohibits the engagement part 7b from projecting outward through the opening part 6e of the receiving recess 6d, and the entire engagement part 7b is located on the inner side from the opening part 6e of the receiving recess 6d. Accordingly, when the lock member 7 is located in the releasing position, even if the grip part (part-to-be-retained) H of an umbrella erected in a vertical posture is moved backward (upward in FIG. 2) between the umbrella retaining lock 5 attached to one side part of one of the mutually adjacent two supporting members 4, 4 and the umbrella retaining lock 5′ attached to the other side part of the other supporting member 4, the grip part H of the umbrella is never abutted with the engagement part 7b and the lock member 7 is not rotated to the locking position side from the releasing position by the grip part H. As shown in FIG. 9, when the lock member 7 is located in the releasing position, almost the entire engagement part 7b is located on the inside of the receiving recess 6d with respect to a line L which passes through the end edge of the recess 6k side in the opening part 6e of the receiving recess 6d, and extends in parallel with the depth direction of the receiving recess 6d. Accordingly, when the grip part H of the umbrella is inserted in the deep side along the depth direction through the opening part 6e of the receiving recess 6d, the grip part H is hardly abutted with the engagement part 7b. Accordingly, an occurrence of a state can be prevented in which the lock member 7 is rotated to the locking position side in accordance with the insertion of the grip part H into the receiving recess 6d and as a result, the grip part H is prohibited from inserting in the deep side of the receiving recess part 6d by the engagement part 7b.

When the lock member 7 is located in the releasing position, the abutment part 7c is projected toward the inside of the receiving recess 6d after passing through the communication hole 61. Accordingly, when the grip part H is inserted into the receiving recess 6d through the opening part 6e along the line L, the grip part H is abutted against the one side surface facing the opening part 6e side of the abutment part 7c. When the grip part H is further inserted into the receiving recess 6d from that position, the lock member 7 is rotated toward the locking position side from the releasing position side against the rotational biasing force of the spring 8. When the lock member 7 arrives at the lock start position shown in FIG. 10, the entire abutment part 7c is brought out of the receiving recess 6d and located on the interior side of the main body part 6. When the abutment part 7c is abutted with a stopper part (not shown) disposed in the main body part 6, the lock member 7 becomes unable to rotate further toward the locking position side from the releasing position side. The location of the lock member 7 at that time is the locking position. The abutment part 7c is abutted against the stopper part by the rotational biasing force of the spring 8, thereby the lock member 7 is maintained in the locking position.

As shown in FIGS. 10 through 12, a key shaft 9 with its axis directing in the up and down direction is disposed within the main body part 6 such that the key shaft 9 is rotatable about its axis but non-movable. The rotating range of this key shaft 9 is restricted between the lock-on position and the lock-off position. The key shaft 9 is normally rotational biased in a direction (opposite direction to the OPEN direction as indicated by an arrow in FIG. 8: clockwise direction in FIG. 9) toward the lock-on position side from the lock-off position side by the spring 10. An engagement hole 9a is formed in the key shaft 9 such that the hole 9a extends through the key shaft 9 along the axis of the key shaft 9. A key 11 is non-rotatably inserted in this engagement hole 9a through a hey hole 6m (see FIG. 5) formed in the upper surface of the upper half member 6A. The key shaft 9 is rotationally operated by the key 11. When the key 11 is located in the lock-on position, the key 11 can be withdrawn from the key hole Gm, but when the key 11 is located in any other position than the lock-on position, the key 11 cannot be withdrawn from the key hole 6m. Since the construction capable of achieving such operation is known and since it is not an essential part of the present invention, either, description thereof is omitted.

A lock member 12 is disposed within the main body part 6. One end part of this lock member 12 is rotatably supported by the main body part 6 through the shaft 13 with its axis directing in the up and down direction. The other end part of the lock member 12 is opposed to the outer peripheral surface of the core part 7a. At least one ratchet tooth 12a is formed on the other end part of the lock member 12 which is opposed to the outer peripheral surface of the core part 7a. When this ratchet tooth 12a is engaged with the ratchet teeth 7d formed on the core part 7a of the lock member 7, the lock member 7 becomes rotatable only from the releasing position side toward the locking position side, and the member 7 is prohibited from rotating from the locking position side toward the releasing position side.

The lock member 12 is normally rotationally biased by a spring (not shown) in a direction where its ratchet toot 12a approaches the core part 7a. However, a cam surface 12b is formed on the opposing surface to the core part 7a of the lock member 12. When the key shaft 9 is located in the lock-off position and the lock member 7 is located in the releasing position, this cam surface 12b is, as shown in FIG. 9, brought to be in parallel with the key shaft 9 and abutted with an engagement shaft part 9b, opposite ends of which are integrally connected to the key shaft 9 (see FIG. 11). By this, the lock member 12 is prohibited from rotating toward the lock member 7 side and the key shaft 9 is prohibited from rotating toward the lock-on position side from the lock-off position.

When the lock member 7 is rotated by a predetermined angle toward the locking position side from the releasing position, the projection 7e is abutted with the engagement shaft part 9b to cause the key shaft 9 to rotate toward the lock-on position side from the lock-off position. When the lock member 7 is arrived at the lock start position shown in FIG. 10, the cam surface 12b allows the key shaft 9 to rotate to the lock-on position, and the key shaft 9 is forcibly rotated to the lock-on position by the biasing force of the spring 10. Then, the engagement shaft member 9b is brought into a recess 12c which is formed continuously on the cam surface 12b. As a result, the lock member 12 becomes rotatable toward the lock member 7 side. When the lock member 12 is rotated toward the lock member 7 side by the rotational biasing force of the spring, the ratchet tooth 12a formed on the distal end part of the lock member 12 is engaged with the ratchet tooth 7d adjacent to the projection 7e of the plurality of ratchet teeth 7d. When the ratchet tooth 12a is engaged with the ratchet tooth 7d, the lock member 7 is prohibited from rotating toward the releasing position side from the locking position side by the lock member 12, and the lock member 7 is allowed to rotate only toward the locking position side. Accordingly, as shown in FIG. 10 or 11, when the grip part H is inserted in the receiving recess 6d until it hits the bottom surface 6f of the receiving recess 6d, the lock member 7 is rotated by the spring 10 toward the locking position side until it is brought to the position in accordance with the thickness of the grip part H. As a result, the grip part H is fixedly sandwiched between the engagement part 7b and the bottom surface 6f. Moreover, since the lock member 7 is never rotated toward the releasing position side, the grip part H is not escaped from the receiving recess 6d.

In case the grip part H is in a state retained by the receiving recess 6d, since the key shaft 9 is rotated to the lock-on position the key 11 can be withdrawn from the engagement hole 9a and the key hole 6m. When the key 11 is withdrawn from the key hole 6m, the key shaft 9 cannot be rotated toward the lock-off position side from the lock-on position side. Thus, the grip part H can hardly be escaped from the receiving recess 6d. In case the grip part H is in the shape of a letter “J”, the grip part H cannot be escaped from the receiving recess 6d unless the lock member 7 is rotated toward the releasing position side. However, in case the grip part H is straight as in a foldable umbrella, the grip part H is easily escaped downward from the receiving recess 6d when it is pushed downward. In order to prevent such a situation from occurring, the core part 7a is provided at an area on its outer peripheral surface facing the receiving recess 6d with a friction member 14 formed of material having a large friction resistance such as rubber. When this friction member 14 is contacted with the grip part H, the grip part H is prohibited as much as possible from escaping in the up and down direction from the receiving recess 6d by the friction resistance generated therebetween.

In case the grip part H is to be escaped from the receiving recess 6d, the key 11 is inserted in the key hole 6m and the engagement hole 9a. And the key shaft 9 is rotated by the key 11 toward the lock-off position side from the lock-on position side against the rotational biasing force of the spring 10. Then, the engagement shaft part 9b is brought into abutment with the side surface continuous with the cam surface 12b of the recess 12c of the lock member 12. The lock member 12 is rotated by the engagement shaft part 9b in such a manner as to be separated from the lock member 7 against the biasing force of the spring. As a result, the engagement between the ratchet teeth 12a, 7d is released, and the lock member 7 becomes rotatable toward the releasing position side from the locking position side. When the key shaft 9 is further rotated toward the lock-off position side by the key 11, the engagement shaft part 9 is brought into abutment with the projection 7e of the lock member 7 so that the lock member 7 is rotated toward the releasing position side from the locking position side. When the lock member 7 is rotated toward the releasing position side beyond, even slightly, the intermediate position in accordance with the rotation of the key shaft 9, the lock member 7 is rotated to the releasing position by the spring 8. The key shaft 9 is rotated to the lock-off position by the key 11 against the biasing force of the spring 10. As a result, the umbrella retaining lock 5 is returned into the original state as shown in FIG. 9. At that time, the key hole 11 is in a state unable to escape from the key hole 6m.

One end part of a shielding member 15 is rotatably connected to an intermediate part between the projection 7e and the engagement part 7b of the entire outer peripheral of the core part 7a. The other end part of this shielding member 15 is movably connected to the shaft 13. When the lock member 7 is located in the releasing position, the shielding member 15 is, as shown in FIG. 9, fully brought into the main body part 6. However, as shown in FIG. 11, when the lock member 7 is located in the locking position, the shielding member 15 shields a part (end part on the recess 6k side) of the communication hole 61 which is opened by the lock member 7 being located in the locking position.

In the umbrella storage apparatus A thus constructed, since the umbrella retaining locks 5, 5′ are disposed at only one supporting member 4, the grip part (part-to-be-retained) H of the umbrella can be inserted in the receiving recess 6d without lifting up the umbrella to a level higher than the umbrella supporting member 4. As shown in FIG. 2 or 3, even in a case where a plurality of umbrella storage apparatuses A are arranged, side by side, in the left and right direction, since a gap opening on the front side in the longitudinal direction of the supporting member 4 is formed between the umbrella retaining locks 5, 5′ of one umbrella storage apparatus A and the umbrella retaining locks 5′, 5 of the umbrella retaining apparatus A adjacent thereto, the umbrella can be moved in the horizontal direction toward the basal end side from the front side of the supporting member 4 through the gap without lifting up the umbrella to a level higher than the supporting member 4 until the umbrella is brought to the empty umbrella retaining lock 5 (5′). Accordingly, there can be prevented a situation from occurring in which the grip part, etc., of other umbrellas already stored in the umbrella storage apparatus A get wet by waterdrops dropping from the umbrella to be stored in the umbrella storage apparatus A. The same is true with respect to the case wherein the umbrella storage apparatuses A are arranged along a normal wall surface. Moreover, since the umbrella retaining locks 5, 5′ are disposed at the opposite side parts of the supporting member 4, the installation number of the umbrella retaining locks 5, 5′ can be increased compared with the case wherein the umbrella retaining locks 5 or 5′ are disposed at only one side part of the supporting member 4.

Next, other embodiments of the present invention will be described. With respect to the embodiments to be described hereinafter, only the construction different from the above embodiment is described, and the identical component parts are denoted by identical reference numeral and description thereof is omitted.

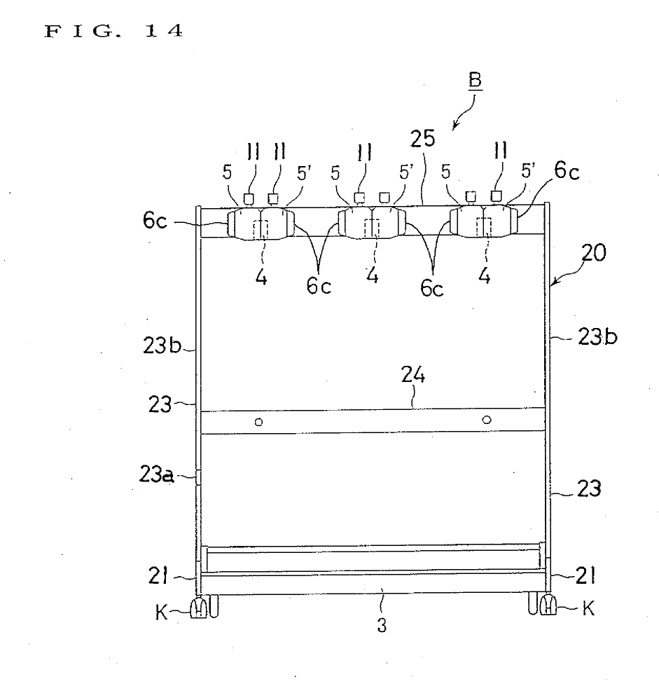

FIGS. 14 through 17 show the second embodiment of the present invention. In an umbrella storage apparatus B of this embodiment, an apparatus main body 20 is used instead of the apparatus main body 1 of the umbrella storage apparatus A of the above embodiment. The apparatus main body 20 includes a pair of basal parts 21, 21 which are mutually separately arranged in the left and right direction. The pair of basal parts 21, 21 are fixedly connected together by a connection member 22 disposed therebetween. A caster K with a stop mechanism is disposed at a front end part and a rear end part of the lower surfaces of the respective basal parts 21, 21. Owing to this arrangement, the umbrella storage apparatus B can easily be moved and the apparatus B can be positionally fixed to a desired place. Supporting column parts 23, 23 are erected in their normal postures from the upper surfaces of the respective basal parts 21, 21. A reinforcement member 24 is suspended at the intermediate parts in the up and down direction of the supporting column parts 23, 23. A rotatable member (retaining member) 25 is rotatably disposed between the upper end parts of the supporting column parts 23, 23 for rotation about a horizontal axis extending in the left and right direction. A basal end part of a water receiving part 3 is rotatably supported between the lower end parts of the supporting column parts 23, 23 for rotation about the horizontal axis.

Basal end parts of a plurality of supporting members 4 are fixed to the rotatable member 25. The respective supporting members 4 mutually separately arranged in the longitudinal direction (left and right direction) of the rotatable member 25. Moreover, the respective supporting members 4 are arranged at the same positions in the peripheral direction of the rotatable member 25 and extend in the same direction in mutually parallel relation. Of course, the respective supporting members 4 extend forward generally in their horizontal postures when in use position and they extend downward generally in their normal postures when in receiving position. A plurality of umbrella retaining locks 5, 5′ are disposed at opposite side parts in the left and right direction of the supporting member 4 along the longitudinal direction of the supporting member 4, respectively. The leftward and rightward adjacent supporting members 4, 4 are separated in the left and right direction with a predetermined distance. That is, in order to form a gap necessary for moving an umbrella in the back and forth direction, the supporting members 4, 4 are separately arranged in the left and right direction between the umbrella retaining locks 5, (5′) disposed at one supporting member 4 and the umbrella retaining locks 5′, (5) disposed at the other supporting member 4 adjacent to the above-mentioned one supporting member 4. The gap formed between the umbrella retaining locks 5, 5′ is open forward of the supporting member 4, so that an umbrella erected upward and downward can be inserted in the gap from the front side in the longitudinal direction of the supporting member 4. Moreover, if the gap formed between the umbrella retaining locks 5, 5′ should be extended to the upper surface of the water receiving part 3, the extended part would be also open forward. Accordingly, the umbrella can be inserted into the gap merely by moving the umbrella toward the upper side from the water receiving part 3. However, instead of opening forward the entire range of the gap, which is formed between the umbrella retaining locks 5, 5′, extending to the water receiving part 3, only the range extending toward the lower side by a predetermined distance from the supporting member 4 may be open as in the sixth embodiment to be described later.

After the supporting member 4 is rotated into the receiving position, the water receiving part 3 is rotated into the folding position and the water receiving part 3 is locked to a lock member 23 disposed at a supporting column part 23, thereby the supporting member 4 and the water receiving part 3 can be positionally fixed to the receiving position and the folding position.

In the umbrella storage apparatus B of this embodiment, in case the grip part H of an umbrella is to be inserted in a receiving recess 6d of the umbrella retaining locks 5, 5′ of this embodiment, the umbrella is erected with the grip part on the upper side, and this umbrella is inserted between the umbrella retaining locks 5, 5′ which are disposed at one and the other side parts of the leftward and rightward adjacent supporting members 4, 4 from the distal end side of the supporting member 4. Then, the umbrella can be inserted in the receiving recess 6d of the empty umbrella retaining lock 5 or 5′. At that time, since the receiving recess 6d is inclined such that depth of the recess 6d becomes deeper toward the basal end side from the distal end side of the supporting member 4, and as a result, the deepest part of the receiving recess 6d is offset toward the basal end side of the supporting member 4 with respect to the center of the receiving recess 6d in the longitudinal direction of the supporting member 4, the grip part H of the umbrella can be inserted in the receiving recess 6d without greatly changing the moving direction of the umbrella. Accordingly, the grip part H can easily be inserted in the receiving recess 6d compared with the conventional umbrella storage apparatus in which the depth direction of the receiving recess 6d is directed in a direction orthogonal to the longitudinal direction of the supporting member 4. For the same reason, the grip part H can easily be taken out of the receiving recess 6d.

In this umbrella storage apparatus B, the casters K, K are located outside of the side surfaces 23b, 23b facing outside in the left and right direction of the supporting column parts 23, 23. However, by providing the caster K on the inner side from the side surface 23b and by making the relation between the side surface 23b and the front surface 6c of the umbrella retaining lock 5 (5′) as in the case with the relation between the comparable components in the first embodiment, the side surface 23b may serve as a reference plane and a plurality of umbrella storage apparatuses B may be arranged side by side leftward and rightward and used in that condition.

FIGS. 18 through 21 show the third embodiment of the present invention. In an umbrella storage apparatus C according to this embodiment, an apparatus main body 30 is used. In this apparatus main body 30, casters K are disposed at the lower surface part of a water receiving surface 3. Lower end parts of a plurality of front supporting column parts (second supporting column parts) 31 which are separately arranged in the left and right direction are fixed to the front surface of the water receiving part 3 and lower end parts of a plurality of rear supporting column parts (supporting column parts) 32 which are separately arranged in the left and right direction are fixed to the rear surface of the water receiving part 3. A front end part and a rear end part of a supporting member 4 extending in a horizontal posture in the back and forth direction are fixedly supported by upper end parts of the front and rear supporting column parts 31, 32 opposing in the back and forth direction. Namely, the supporting member 4 is supported in a cantilever supporting fashion in the above-mentioned two embodiments, while in the umbrella storage apparatus C of this embodiment, the supporting member 4 is supported in a two parts supporting fashion. The side surfaces (reference planes) 3a, 3b directing in the left and right direction of the water receiving part 3 are located at outer sides in the left and right direction from any part of the entire umbrella storage apparatus C, and they are separated from the respective front surfaces of the umbrella retaining locks 5, 5′ with the same relation as the relation between the reference planes 2d, 2e and the front surface 6c of the first embodiment. Accordingly, in the plurality of umbrella storage apparatuses C, by arranging one umbrella storage apparatus C and other umbrella storage apparatuses C, side by side, in the left and right direction with the side surface 3a (3b) of the one umbrella storage apparatus and the side surfaces 3b (3a) of the other umbrella storage apparatuses C surface-contacted with each other, the plurality of umbrella storage apparatuses C can be used as if they were one umbrella storage apparatus. All the other construction is same as in the above-mentioned umbrella storage apparatus B.

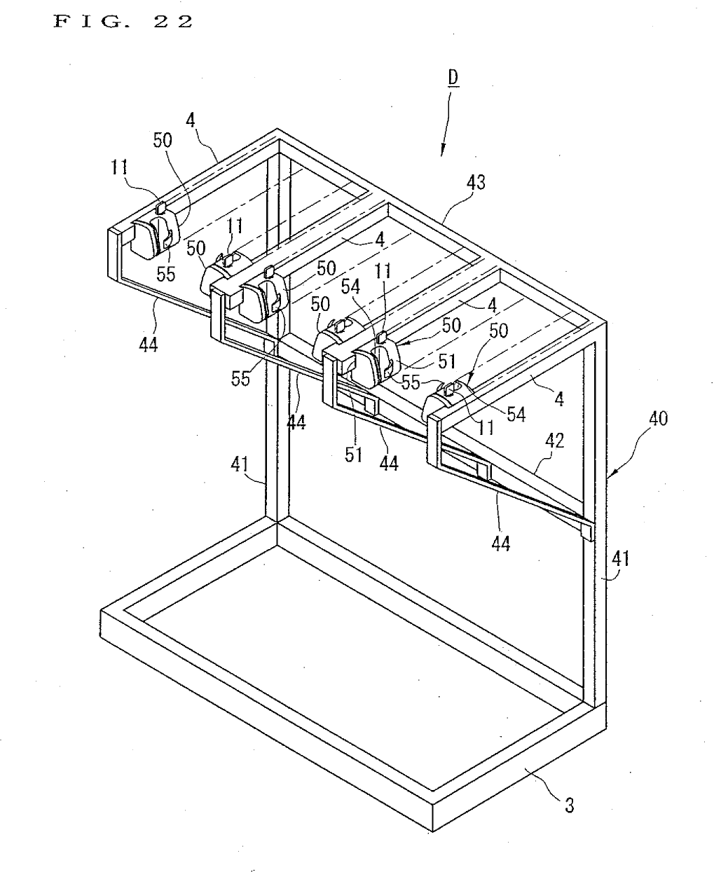

FIGS. 22 through 26 show the fourth embodiment of the present invention. In an umbrella storage apparatus D of this embodiment, an apparatus main body 40 is used instead of the apparatus main body 20 of the umbrella storage apparatus B. Two supporting column parts 41 are fixedly erected from the upper surface of a water receiving part 3 of the apparatus main body 40. Two supporting column parts 41, 41 are arranged at the opposite left and right corner parts on the rear end side of the upper surface of the water receiving part 3, respectively. Reinforcement connection members 42 are disposed between the intermediate parts in the up and down direction of the supporting column parts 41, 41. One end part and the other end part of a retaining member 43 extending horizontally in the left and right direction are integrally disposed at the upper end parts of the supporting column parts 41, 41. Basal end parts of a plurality of supporting members 4 are integrally disposed at the front surface of a retaining member 43. Accordingly, in this apparatus main body 40, the supporting column parts 41, the retaining member 43 and the supporting members 4 are integrally disposed. Of course, it is accepted that the supporting column parts 41, the retaining member 43 and the supporting members 4 are separately made and then they are mutually fixed together. The respective supporting members 4 extend horizontally forward and in mutually parallel relation from the retaining member 43. Of course, the leftward and rightward adjacent supporting members 4, 4 are separated at a predetermined distance. Reinforcement members 44 are disposed between the distal end parts of the supporting members 4 which are arranged at the opposite left and right ends and the supporting column parts 41, and between the distal end parts of the supporting members 4 which are arranged at the intermediate parts in the left and right direction and the connection member 42.

Umbrella retaining locks 50 instead of the umbrella retaining locks 5, 5′ are disposed at a right side part of the supporting member 4 which is arranged at the left end, a left side part of the supporting member 4 which is arranged at the right end, and the left and right side parts of the supporting member 4 which are arranged at the intermediate part. Each umbrella retaining lock 50 includes a main body part 51. An attachment recess 52 is formed in a rear surface of this main body part 51. On side part of the supporting member 4 is fitted to this attachment recess 52. The main body part 51 is fixed to the supporting member 4 by fixing means such as a machine screw (not shown).

A receiving recess 54 is formed in a front surface part 53 facing in the left and right direction of the main body part 51 in such a manner as to vertically divide the front surface part 53 in the up and down direction. In case of an umbrella having a grip part (part-to-be-retained) formed, for example, in a shape of a letter “J”, the linear upper end part (the lower end part when the umbrella is stored therein in its up-side-down posture) of the umbrella is removably inserted in this receiving recess 54. In case of an umbrella, such as a foldable umbrella having a large and thick grip part, a part of an intermediate shaft extending upward (downward when the umbrella is stored therein in its up-side-down posture) from the grip part and located in the vicinity of the grip part is removably inserted in the receiving recess 54. The main body part 51 is provided with an opening and closing member 55 bent to have a generally arcuate shape. A part of this opening and closing member 55 projects from a front surface part 53 of the main body part 51. The opening and closing member 55 is disposed at a location adjacent to the receiving part 54 in the back and forth direction. That is, in the umbrella retaining lock 50 which is disposed at the right side part of the supporting member 4, the opening and closing member 55 is disposed behind the receiving recess 54, while in the umbrella retaining lock 50 which is disposed at the left side part of the supporting member 4, the opening and closing member 55 is disposed in front of the receiving recess 54. This arrangement results in that same umbrella retaining locks are used as the umbrella retaining locks 50, 50 which are arranged at the left and right side parts of the supporting member 4. Of course, the umbrella retaining locks 5, 5′ may be used instead of the umbrella retaining lock 50.

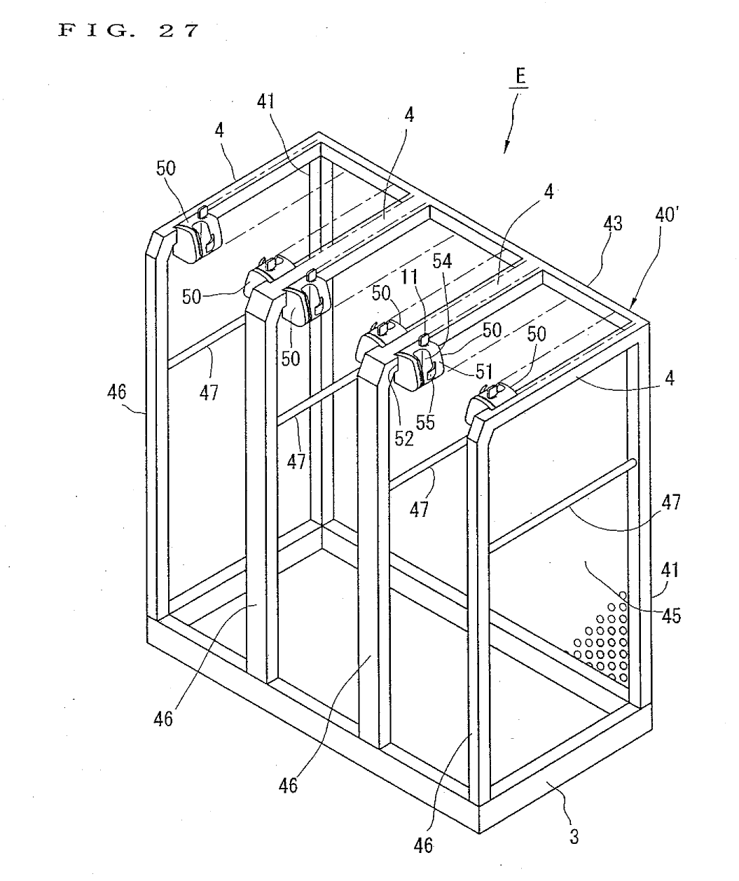

The opening and closing member 55, just like the opening and closing member of an umbrella retaining lock disclosed in Japanese Utility Model Application Laid-Open No. H04-20585, for example, is retractably rotatable between an open position as indicated by a solid line of FIG. 26 and a closed position as indicated by an imaginary line. When an umbrella is inserted into the receiving recess 54 until its grip part or intermediate shaft is almost abutted with the bottom surface of the receiving recess 54 and a control projection (not shown) projecting from the bottom surface of the receiving recess 54 is pushed by the grip part or intermediate shaft toward the bottom surface side until it reaches a predetermined location, the opening and closing member 55 located in the open position is rotationally displaced into the closed position against biasing means which is installed within the main body part 51. When rotationally moved into the closed position, the opening and closing member 55 is locked to the closed position by a latch mechanism (not shown) which is installed within the main body part 51. In this state, since a part of an opening part on the front side of the receiving recess 54 is closed by the opening and closing member 55, the grip part or intermediate shaft of the umbrella cannot be removed from the receiving recess 54, and a key 11 for releasing the latch mechanism is rotated by about 90 degrees in one direction (for example, clockwise direction) from the state shown in FIG. 26, so that the key 11 can be withdrawn from a key hole (not shown) formed in the upper surface of the main body part 51. When the key 11 is withdrawn from the key hole, the opening and closing member 55 is locked to the closed position. On the other hand, when the key 11 is inserted into the key hole and rotated by about 90 degrees but in the opposite direction, the locked state of the opening and closing member 55 caused by the latch mechanism is released, and the opening closing member 55 is rotationally displaced into the open position by biasing means. In this state, the grip part or intermediate shaft of the umbrella can be withdrawn from the receiving recess 54 but the key 11 cannot be withdrawn from the key hole.

FIGS. 27 through 30 show the fifth embodiment of the present invention. An umbrella storage apparatus E of this embodiment is a modification of the umbrella storage apparatus D and an apparatus main body 40′ is used instead of the apparatus main body 40. In the apparatus main body 40′, a rear surface opening part of the apparatus main body 40′ which is defined by a supporting column part 41, a retaining member 43 and a water receiving part 3 is closed by a punch board 45. Second column parts 46 extending up and down are disposed between front end parts of supporting members 4 and a front end part of the upper surface of the water receiving part 3. Although the second supporting column parts 46 are integrally formed with the supporting members 4, they may be separately formed and then fixed to the supporting members 4 by bonding or other fixing means. Reinforcement members 47 are disposed between the intermediate parts in the up and down direction of the second supporting column parts 46 and the supporting column parts 41 which are arranged at the left and right end parts and between the second supporting column parts which are arranged at the intermediate parts in the left and right direction and the punch board 45.

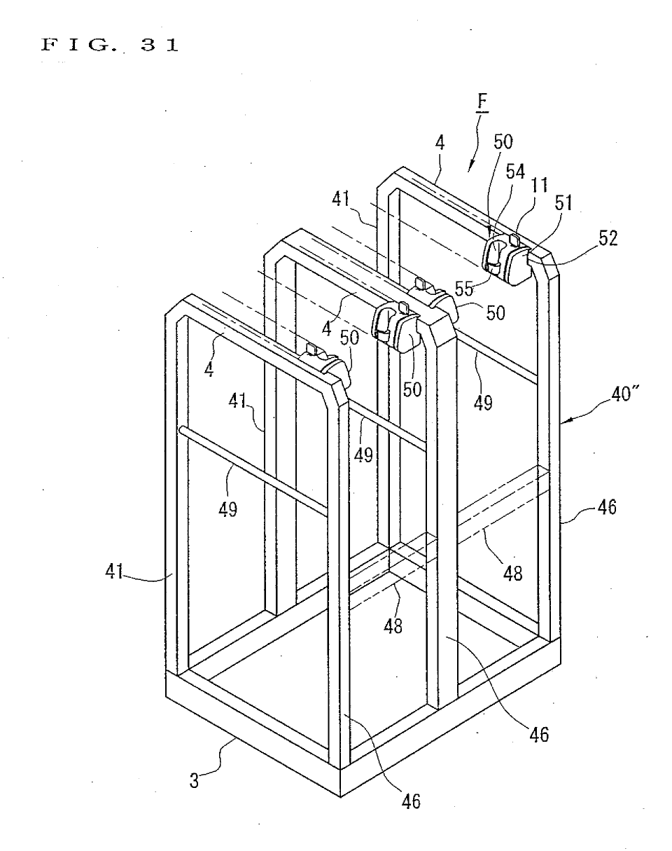

FIGS. 31 through 34 show the sixth embodiment of the present invention. In an apparatus main body 40″ of an umbrella storage apparatus F of this embodiment, a plurality of supporting column parts 41 erected from one left and right side part of the upper surface of a water receiving part 3, and second supporting column parts 46 are erected from the other side part. The supporting column parts 41 are arranged at a predetermined distance in the back and forth direction. The second supporting column parts 46 are arranged at the same distance as the supporting column parts 41 likewise in the back and forth direction and placed opposite to the supporting column parts 41 in the left and right direction. One and the other end parts of the supporting members 4 horizontally extending in the left and right direction are integrally disposed at the upper end parts of the supporting column parts 41 and the second supporting column parts 46 which are mutually opposed to each other in the left and right direction. Umbrella retaining locks 50 are disposed at a side part of a rear end side of a supporting member 4 disposed at a front end, a side part of a front end side of the supporting member 4 disposed at a rear end, and each of opposite side parts of the supporting member disposed at an intermediate part in the back and forth direction. Every front and rear two adjacent supporting members 4, 4 are separately arranged by a predetermined distance in the back and forth direction, so that an umbrella can be inserted between the umbrella retaining locks 50, 50. A gap formed between the umbrella retaining locks 50, 50 and a clearance formed by extending this gap to the water receiving part 3 are open in the left and right direction from the opposite left and right end parts of each supporting member 4. As indicated by imaginary lines in FIG. 31, by providing a reinforcement member 48 between the intermediate parts in the up and down direction of every adjacent front and rear second supporting column parts, the clearance may be open in the left and right direction by a range restricted by the reinforcement member 48 downward from the supporting member 4. A reinforcement member 48 is disposed between the intermediate parts of each supporting column part 41 and each second supporting column part 46 which is opposite to the supporting column part 41 in the left and right direction.

In this umbrella storage apparatus F, the gap formed between the umbrella retaining locks 50, 50 which are disposed at the supporting members 4, 4 which are adjacent in the back and forth direction, and the clearance obtained by extending this gap to the water receiving part 3 are open in the left and right direction from the opposite left and right end parts of the supporting members 4, 4. Accordingly, in case an umbrella is to be retained by the umbrella retaining lock 50, the umbrella can be inserted between the umbrella retaining locks 50, 50 through the left side and right side opening parts, and inserted in the receiving recess 54 of the empty umbrella retaining lock 50.

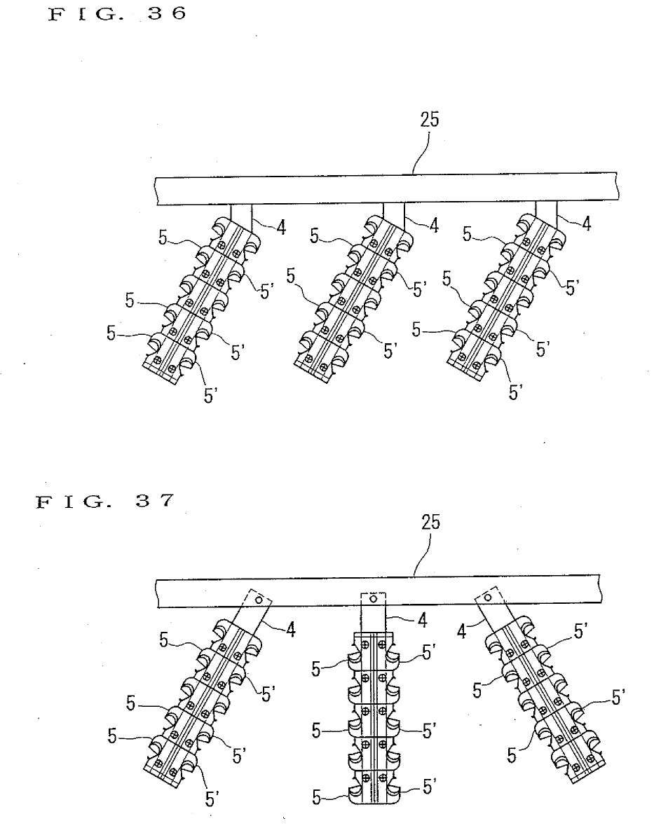

FIG. 35 shows another example of an umbrella retaining lock suited to be used for an umbrella storage apparatus according to the present invention. In this umbrella retaining lock 60, an attachment recess 62 is formed in a rear surface part of the main body part 61. This attachment recess 62 transverses the rear surface part in the longitudinal direction of the supporting member 4. After one side part of the supporting member 4 is inserted in this attachment recess 62, the main body part 61 is fixed to the supporting member 4 by fixing means such as a machine screw. A front surface 63 of the main body part 61 is generally in parallel to the longitudinal direction of the supporting member 4. A retaining body 64 is disposed at one end part of the front surface 63 in the longitudinal direction of the supporting member 4. This retaining body 64 includes a vertical part 64a projecting forward from the front surface 63 and a horizontal part 64b horizontally extending from the distal end side of the vertical part 64a to the other end side along the front surface 63. A receiving recess 65 whose opposite ends in the up and down direction is open and whose one side part facing the other end side of the main body part 61 is open, is defined by a vertical part 64a, the horizontal part 64b and the front surface 63. A part-to-be-retained, such as, a grip part or an intermediate shaft part of an umbrella are inserted in this receiving recess 65 all the way therethrough in the up and down direction.

A window hole 66 is formed in the other end part of the front surface 63 of the main body 61. An opening and closing member 67 is inserted in this window hole 66. This opening and closing member 67 is placed within the main body part 21 such that the member 67 is retractable and displaceable with respect to the front surface 63. The opening and closing member 67 is placed within the main body part 21 such that the member 67 is rotationally displaceably between an open position where the entire opening and closing member 67 is brought into the window hole 66, and a closed position where one end part is projected through the window hole 66 and proximate in opposing relation to the distal end part of the horizontal part 64b. When the opening and closing member 67 is displaced to the open position, the part-to-be-retained of the umbrella can be inserted in and withdrawn from the receiving recess 65. When the opening and closing member 67 is displaced to the closed position, the part to be retain, which is inserted in the receiving recess 65, cannot be escaped from the receiving recess 65.

In case the umbrella retaining lock 60 thus constructed is to be used in an umbrella storage apparatus, the umbrella retaining lock 60 is attached to the supporting member 4. In this case, the umbrella retaining lock 60 is attached to the supporting member 4 such that one end opening part of the receiving recess 65 faces the open end part side of the gap between the supporting members 4, 4 which are adjacent to each other in the left and right direction. In the umbrella retaining apparatus with the umbrella retaining lock 60 attached thereto, the umbrella is inserted between the supporting members 4, 4 through its open end part side, and simply moved along the front surface 63 of the umbrella retaining lock 60. By doing so, the part-to-be-retained of the umbrella can be inserted into the receiving recess 65. When the key 11 is rotated by about 90 degrees from the opening position shown in FIG. 35 to the closed position after the part-to-be-retained is inserted in the receiving recess 65, the opening and closing member 67 closes the opening part of the receiving recess 65. By this, the umbrella is stored in the umbrella storage apparatus. Thereafter, the key 11 is withdrawn from the key hole (not shown).

In case the umbrella stored in the umbrella storage apparatus is to be removed therefrom, the key 11 is inserted in the key hole and rotated into the open position. Then, the opening and closing member 67 is displaced into the open position to open the receiving recess. Then, by moving the umbrella in to opposite direction to the direction at the time of inserting the umbrella in the umbrella storage apparatus, the umbrella is withdrawn from the receiving recess 65 and also withdrawn between the supporting members 4, 4 through the opening part.

FIG. 36 shows an essential part of the seventh embodiment of an umbrella storage apparatus according to the present invention. In this embodiment, the supporting members 4 are bent at their basal end parts on the retaining member 25 side. As a result, a part on the distal end side from the bent part of each supporting member 4 is diagonally, instead of orthogonally, extended with respect to the retaining member 25. And umbrella retaining locks 5, 5′ are disposed at opposite side parts of the part on the distal end side which is inclined with respect to the retaining member 25.

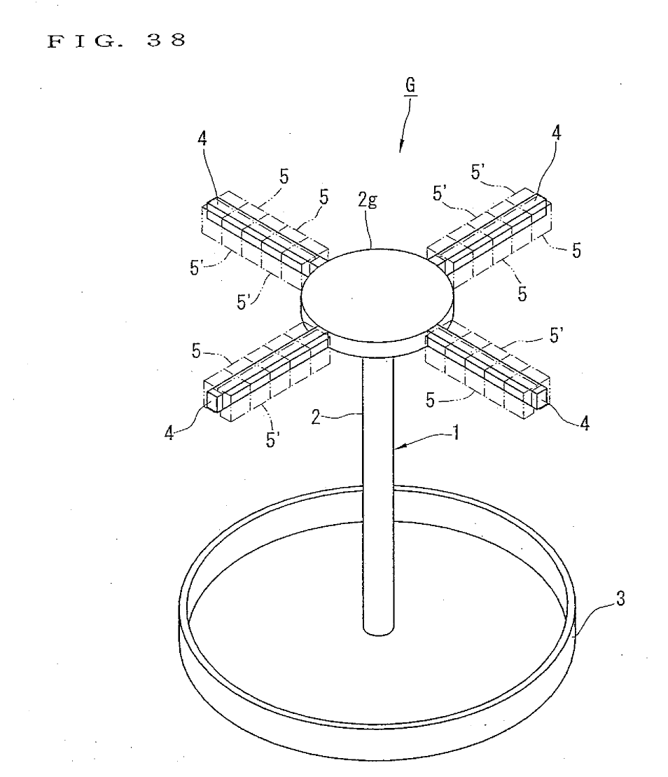

FIG. 37 shows an essential part of the eighth embodiment of an umbrella storage apparatus according to the present invention. In this embodiment, the basal end part of each supporting member 4 is supported by a retaining member 25 such that the supporting member 4 is horizontally rotatable about an axis extending in the up and down direction. Accordingly, the respective supporting members 4 can be used in their postures directing in desired directions. After being directed in desired directions, the respective supporting members 4 are fixed to the retaining member 25 by fixing means which is disposed between each supporting member 4 and the retaining member 25.

FIG. 38 shows the ninth embodiment of an umbrella storage apparatus according to the present invention. In an umbrella storage apparatus G of this embodiment, a water receiving part 3 is formed in a circular shape. A supporting column part 2 is fixedly erected in its normal posture from the central part of the water receiving part 3. A disc part 2g is disposed at an upper end part of the supporting column part 2. Basal end parts of a plurality (four in this embodiment) of supporting members 4 are fixed to the outer peripheral surface of this disc part 2g. The respective supporting members 4 are equidistantly arranged in the peripheral direction of the disc part 2g. Moreover, the supporting members 4 are radially arranged at the disc part 2g with their longitudinal direction directing in the horizontal direction. A plurality of umbrella retaining locks 5, 5′ are disposed at the opposite side parts of each supporting member 4. Every adjacent supporting members 4, 4 in the peripheral direction of the disc part 2g are horizontally separately arranged by a predetermined distance so that an umbrella can be inserted between the distal end parts toward the basal end side and further inserted between the umbrella retaining locks 5, 5′.

The present invention is not limited to the above-mentioned embodiments but many changes and modifications can be made in accordance with necessity.

For example, in the above embodiment, the supporting members 4 located in a use position, are horizontally arranged. However, it is also accepted the supporting members 4 are inclined downward in the forward direction.

In the umbrella storage apparatus according to the present invention, the wall part of the skeleton structure of a house or building may serve as the apparatus main body. In that case, a recess extending upward and downward is formed in the wall surface of the wall part serving as the apparatus main body. A supporting member is disposed at an upper end part of this recess such that the supporting member is rotatable between a used position and a receiving position, and a water receiving part is disposed at a lower end part of the recess such that the water receiving part is rotatable between a water receiving position and a folding position. A part, which is adjacent either in the left or right direction with respect to the recess formed in the wall surface of the skeleton structure is provided with a cosmetic cover. The supporting member and the water receiving part rotated into the receiving position and the folding position, respectively, and umbrella retaining locks attached to the supporting member are receiving in the recess. Then, the recess is closed by the cosmetic cover rotated into the closed position from the open position, so that the supporting member, the water receiving part and the umbrella retaining locks are shielded from the outside.

Moreover, a plurality of supporting members 4 may be integrally formed. This will be hereinafter described with reference to the example of the above-mentioned umbrella storage apparatus G. The umbrella storage apparatus G can be modified in the following manner. That is, the supporting column part 2 is merely formed in a circular column-like shape without providing the disc part 2g on the upper end part of the supporting column part 2. Of four supporting members 4, two supporting member 4 arranged on a straight line are mutually integrally formed. Then, an intermediate part of the integrally formed supporting member is fixedly placed on the upper end face of the supporting column part 2. The basal end parts of the remaining two supporting members 4, 4 arranged on another straight line are fixed to the opposite side surfaces of the intermediate part of the integrally formed supporting member. In an umbrella storage apparatus thus constructed, the intermediate part of the integrally formed supporting member constitutes the both basal end parts of the supporting member 4 on one end side in the longitudinal direction and the supporting member 4 on the other end side. Moreover, one end part and the other end part of the integrally formed supporting member constitute the distal end parts of the respective supporting members 4, 4, respectively.

### INDUSTRIAL APPLICABILITY

The present invention can be utilized as an umbrella storage apparatus which is designed such that the grip parts, etc. of the umbrellas already stored will not get wet by waterdrops dropping from the umbrellas which are to be stored thereafter.

1.-13. (canceled)

14. An umbrella retaining lock including a lock main body formed in a front surface thereof with a receiving recess extending in the up and downward direction and open forward, and a lock member disposed at said lock main body such that said lock member is displaceable between an releasing position and a locking position, said lock member, when located in the releasing position, allowing a part-to-be-retained of an umbrella to be brought in and out of said receiving recess through said opening part, and when located in the locking position, prohibiting the part-to-be-retained of the umbrella from escaping from said receiving recess through said opening part,
wherein a deepest part of said receiving recess is offset in the horizontal direction along the front surface of said lock main body with respect to a central part in said horizontal direction of said opening part of said receiving recess.

15. An umbrella retaining lock including a lock main body formed in a front surface thereof with a receiving recess extending in the up and downward direction and open forward, and a lock member disposed at said lock main body such that said lock member is displaceable between a releasing position and a locking position, said lock member, when located in the releasing position, allowing a part-to-be-retained of an umbrella to be brought in and out of said receiving recess through said opening part, and when located in the locking position, prohibiting the part-to-be-retained of the umbrella from escaping from said receiving recess through said opening part,
wherein a depth direction of said receiving recess is inclined with respect to the front surface of said lock main body so that the depth of said receiving recess becomes deeper toward the horizontal direction along the front surface of said lock main body.

16. An umbrella retaining lock according to claim 14, wherein a movable member with a part thereof projecting from a bottom surface of said receiving recess is disposed at said apparatus main body such that said movable member is displaceable in the depth direction of said receiving recess, and said movable member is connected to said lock member so that when said movable member is abutted with the part-to-be-retained of the umbrella inserted in said receiving recess and then displaced toward the deep side of said receiving recess together with the part-to-be-retained, said lock member is displaced toward the locking position side from the releasing position interlocking with said displacement of said movable member.

17. An umbrella retaining lock according to claim 16, wherein an intermediate part located within said apparatus main body of said lock member is rotatably disposed at said apparatus main body for rotation about an axis extending in the up and down direction, said lock member is provided at one end part thereof projecting toward the outside from said apparatus main body with an engagement part for prohibiting the part-to-be-retained of the umbrella from escaping from the opening part of said receiving recess when said lock member is located in the locking position, and said movable member is integrally disposed at the other end part projecting from a bottom surface within said receiving recess of said lock member.

18. An umbrella retaining lock according to claim 17, wherein the bottom surface of said receiving recess includes a pair of side surfaces extending in parallel relation to each other toward the deep side of said receiving recess from an opening part thereof, and a deep surface disposed between end parts on the deep side of said pair of side surfaces, a recess is formed in an area in the vicinity of an opening part of a side surface opposing the opening part of said receiving recess of said pair of side surfaces, and a part of said engagement part is received in said recess so that when said lock member is located in the releasing position, said engagement part is not projected toward the outside from the opening part of said receiving recess and a part-to-be-retained of an umbrella inserted in said receiving recess through the opening part thereof is not abutted with said engagement part.

19.-21. (canceled)

22. An umbrella retaining lock according to claim 15, wherein a movable member with a part thereof projecting from a bottom surface of said receiving recess is disposed at said apparatus main body such that said movable member is displaceable in the depth direction of said receiving recess, and said movable member is connected to said lock member so that when said movable member is abutted with the part-to-be-retained of the umbrella inserted in said receiving recess and then displaced toward the deep side of said receiving recess together with the part-to-be-retained, said lock member is displaced toward the locking position side from the releasing position interlocking with said displacement of said movable member.

23. An umbrella retaining lock according to claim 22, wherein an intermediate part located within said apparatus main body of said lock member is rotatably disposed at said apparatus main body for rotation about an axis extending in the up and down direction, said lock member is provided at one end part thereof projecting toward the outside from said apparatus main body with an engagement part for prohibiting the part-to-be-retained of the umbrella from escaping from the opening part of said receiving recess when said lock member is located in the locking position, and said movable member is integrally disposed at the other end part projecting from a bottom surface within said receiving recess of said lock member.

24. An umbrella retaining lock according to claim 23, wherein the bottom surface of said receiving recess includes a pair of side surfaces extending in parallel relation to each other toward the deep side of said receiving recess from an opening part thereof, and a deep surface disposed between end parts on the deep side of said pair of side surfaces, a recess is formed in an area in the vicinity of an opening part of a side surface opposing the opening part of said receiving recess of said pair of side surfaces, and a part of said engagement part is received in said recess so that when said lock member is located in the releasing position, said engagement part is not projected toward the outside from the opening part of said receiving recess and a part-to-be-retained of an umbrella inserted in said receiving recess through the opening part thereof is not abutted with said engagement part.
